(19) United States
(12) Patent Application Publication
(10) Pub. No.: US 2017/0364854 A1
(43) Pub. Date: Dec. 21, 2017

(54) INFORMATION PROCESSING DEVICE, CONDUCT EVALUATION METHOD, AND PROGRAM STORAGE MEDIUM

(71) Applicant: NEC Corporation, Tokyo (JP)

(72) Inventors: Terumi UMEMATSU, Tokyo (JP); Ryosuke ISOTANI, TOKYO (JP); Yoshifumi OMISHI, Tokyo (JP); Masanori TSUJIKAWA, Tokyo (JP); Makoto TERAO, Tokyo (JP); Tasuku KITADE, Tokyo (JP); Shuji KOMEIJI, Tokyo (JP)

(21) Appl. No.: 15/532,778

(22) PCT Filed: Dec. 2, 2015
(86) PCT No.: PCT/JP2015/005984

§ 371 Date: Jun. 2, 2017

(30) Foreign Application Priority Data
Dec. 4, 2014 (JP) 2014-245898

(51) Int. Cl. G06Q 10/06; G06Q 30/00

(52) U.S. Cl. CPC G06Q 10/06398; G06Q 30/016

(57) ABSTRACT

The purpose of the present invention is to provide a technology which is capable of appropriately evaluating a person's conduct with respect to another person. Provided is an information processing device, comprising a recognition unit 11, a detection unit 12, and an evaluation unit 13. The recognition unit 11 recognizes an evaluation subject's conduct. The detection unit 12 detects a trigger which is a state of a person other than the evaluation subject which triggers the evaluation subject's conduct. Using the detected trigger and the result of recognition by the recognition unit 13 relating to the evaluation subject's conduct, the evaluation unit 13 evaluates the evaluation subject's conduct.

### TECHNICAL FIELD

The present invention relates to a technology of evaluating a conduct of a person toward another person.

### BACKGROUND ART

PTL 1 proposes a technique of automatically rating a reception of an operator at a call center or the like. In the proposed technique, an emotion sequence for each call is generated using a voice feature detected from a received voice signal of a customer, and a previously given emotion model. Then, the emotion sequence is converted into an emotion score sequence, and a rating of a reception of an operator is calculated based on the emotion score sequence.

PTL 2 proposes a technique of recording customer service data in order to grasp relevance of a conversation ratio to a customer satisfaction level. In the proposed technique, a section (time segment) in which a clerk initiates a conversation, and a section (time segment) in which a customer initiates a conversation are extracted from conversations between the clerk and the customer. Then, a time ratio (conversation ratio) of the conversations between the clerk and the customer is calculated based on an extracted time length of each section. Further, a customer satisfaction level is calculated based on a customer emotion recognized from a voice in a section in which the customer initiates a conversation. Then, the calculated conversation ratio and customer satisfaction level are recorded in a mutually associated state.

PTL 3 describes use of an image of headgear worn by a clerk, a face image of a clerk, and an image of a uniform as images for distinguishing a skill level of commodity sales registration (referring to paragraph [0025] in PTL 3). PTL 4 describes that a face recognition chip mounted on a control unit acquires a feature value of a face required for personal authentication and facial expression recognition from a captured image, and a customer stratum is determined from the feature value (referring to paragraphs [0034] and [0050] in PTL 4). PTL 5 describes that a frame number of voice information, a frame number of a video image signal, and playback time information thereof are stored in a mutually associated state (referring to paragraph [0045]in PTL 5). PTL 6 describes a technique of recognizing emotions of a clerk and a customer based on conversation voices of the clerk and the customer, and calculating a clerk satisfaction level and a customer satisfaction level based on the recognition results. PTL 7 describes that a table storing sales data at each point of sale (POS) terminal is composed of a record including data such as a date and a time period (referring to paragraph [0025] in PTL 7). PTL 8 describes associating categories among different types of classification systems with each other (referring to paragraph [0033] in PTL 8). PTL 9 describes capturing an image of a subject such as a person moving in front of a background, and recognizing the movement of the subject such as a person from the captured image (dynamic image data) (referring to paragraph [0032]in PTL 9).

### CITATION LIST

### Patent Literature

PTL 1: Japanese Unexamined Patent Application Publication No. 2007-286377

PTL 2: Japanese Unexamined Patent Application Publication No. 2011-238028

PTL 3: Japanese Unexamined Patent Application Publication No. 2013-37452

PTL 4: Japanese Unexamined Patent Application Publication No. 2013-20366

PTL 5: Japanese Unexamined Patent Application Publication No. 2013-5423

PTL 6: Japanese Unexamined Patent Application Publication No. 2011-238029

PTL 7: Japanese Unexamined Patent Application Publication No. 2008-139951

PTL 8: Japanese Unexamined Patent Application Publication No. 2005-63332

PTL 9: Japanese Unexamined Patent Application Publication No. 2002-123834

### SUMMARY OF INVENTION

### Technical Problem

In the techniques proposed in PTLs 1 and 2, properness of an utterance of an evaluated person or a conversation between an evaluated person and another person is evaluated. However, a conduct of an evaluated person (clerk) toward a customer cannot be solely evaluated by an utterance content, or emotion information obtained from a conversation voice. An utterance content satisfying a customer by a clerk varies with a situation. For example, it is desirable in Japan that a clerk say “How are you?,” when a customer enters a store. When a customer leaves a store, it is desirable that a clerk say “Thank you very much.” Further, an utterance content, a voice level, and the like required for a clerk may vary with an age group and a state of a customer. Furthermore, in addition to a speech, as action related to a conversation such as stepping up to a customer, crouching down, and bowing may be required for a clerk based on a situation such as a conversation content.

As described above, a conduct of a clerk toward a customer cannot be solely evaluated by an utterance content, or emotion information obtained from a conversation voice, and therefore the techniques described in PTLs 1 and 2 may not be able to properly evaluate a conduct of a clerk toward a customer.

The present invention is made to solve the aforementioned problem. That is to say, a main object of the present invention is to provide a technology that is able to properly evaluate a conduct of a person toward another person.

### Solution to Problem

To achieve the main object, an information processing device includes, as an aspect,

a recognition unit that recognizes a conduct of an evaluated person;

a detection unit that detects a trigger state which is a state of a person other than the evaluated person and a state of triggering the conduct of the evaluated person; and

an evaluation that evaluates the conduct of the evaluated person using the trigger state detected by the detection unit and a recognition result by the recognition unit, the recognition result being related to the conduct of the evaluated person.

An information processing device of the present Invention includes, as another aspect,

a recognition unit that recognizes a conduct of an evaluated person;

an attribute acquisition unit that acquires attribute information of a person which is other than the evaluated person, the person performing a conduct which triggers the conduct of the evaluated person; and

an evaluation unit that evaluates the conduct of the evaluated person using a designated conduct predetermined and the conduct of the evaluated person recognized by the recognition unit, the designated conduct being the conduct of the evaluated person related to the attribute information acquired by the attribute acquisition unit.

An information processing device of the present invention includes, as another aspect,

a recognition unit that recognizes a conduct of an evaluated person;

an information acquisition that acquires information about a target commodity to be purchased by a person which is other than the evaluated person, the person performing a conduct which triggers the conduct of the evaluated person; and

an evaluation unit that evaluates the conduct of the evaluated person using a designated conduct predetermined and the conduct of the evaluated person recognized by the recognition unit, the designated conduct being the conduct of the evaluated person related to the target commodity information acquired by the information acquisition unit.

A conduct evaluation method of the present invention includes, as an aspect,

by a computer,

recognizing a conduct of an evaluated person;

detecting a trigger state which is a state of a person other than the evaluated person and a state of triggering the conduct of the evaluated person; and

evaluating the conduct of the evaluated person using the trigger state detected, and a recognition result related to the conduct of the evaluated person recognized.

A conduct evaluation method of the present invention includes, as another aspect,

by a computer,

recognizing a conduct of an evaluated person;

acquiring attribute information of a person which is other than the evaluated person, the person performing a conduct which triggers the conduct of the evaluated person; and

evaluating the conduct of the evaluated person using a designated conduct predetermined and the conduct of the evaluated person recognized, the designated conduct being the conduct of the evaluated person related to the attribute information acquired.

A conduct evaluation method of the present invention includes, as another aspect,

by a computer,

recognizing a conduct of an evaluated person;

acquiring information about a target commodity to be purchased by a person which is other than the evaluated person, the person performing a conduct which triggers the conduct of the evaluated person; and

evaluating the conduct of the evaluated person using a designated conduct predetermined and the conduct of the evaluated person recognized, the designated conduct being the conduct of the evaluated person related to the target commodity information acquired.

A computer program storage medium of the present invention, as an aspect, storing a processing procedure causing a computer to perform:

recognizing a conduct of an evaluated person;

detecting a trigger state which is a state of a person other than the evaluated person and a state of triggering the conduct of the evaluated person; and

evaluating the conduct of the evaluated person using the trigger state detected and a recognition result which is related to the conduct of the evaluated person.

A computer program storage medium of the present invention, as another aspect, storing a processing procedure causing a computer to perform:

recognizing a conduct of an evaluated person;

acquiring attribute information of a person which is other than the evaluated person, the person performing a conduct which triggers the conduct of the evaluated person; and

evaluating the conduct of the evaluated person using a designated conduct predetermined and the conduct of the evaluated person recognized, the designated conduct being the conduct of the evaluated person related to the attribute information acquired.

A computer program storage medium of the present invention, as another aspect, storing a processing procedure causing a computer to perform:

recognizing a conduct of an evaluated person;

acquiring information about a target commodity to be purchased by a person which is other than the evaluated person, the person performing a conduct which triggers the conduct of the evaluated person; and

evaluating the conduct of the evaluated person using a designated conduct predetermined and the conduct of the evaluated person recognized, the designated conduct being the conduct of the evaluated person related to the target commodity information acquired.

The aforementioned main object of the present invention is also achieved by a conduct evaluation method according to the present invention, being related to the information processing device according to the present invention. Additionally, the aforementioned main object of the present invention is also achieved by a computer program related to the information processing device according to the present invention and the conduct evaluation method according to the present invention, and a program storage medium storing the computer program.

### Advantageous Effects of Invention

The present invention is able to properly evaluate a conduct of a person toward another person.

### BRIEF DESCRIPTION OF DRAWINGS

FIG. 1 is a diagram conceptually illustrating a hardware configuration of an information processing device (evaluation device) according to a first example embodiment.

FIG. 2 is a block diagram conceptually illustrating a control configuration of the information processing device (evaluation device) according to the first example embodiment.

FIG. 3 is a diagram illustrating an example of a rule table according to the first example embodiment.

FIG. 4 is a flowchart illustrating an operation example of the information processing device (evaluation device) according to the first example embodiment.

FIG. 5 is a flowchart illustrating another operation example of the information processing device (evaluation device) according to the first example embodiment.

FIG. 6 is a block diagram conceptually illustrating a control configuration of an information processing device (evaluation device) according to a second example embodiment.

FIG. 7 is a diagram illustrating an example of a rule table according to the second example embodiment.

FIG. 8 is a flowchart illustrating an operation example of the information processing device (evaluation device) according to the second example embodiment.

FIG. 9 is a flowchart illustrating another operation example of the information processing device (evaluation device) according to the second example embodiment.

FIG. 10 is a block diagram conceptually illustrating a control configuration of an information processing device (evaluation device) according to a third example embodiment.

FIG. 11 is a diagram illustrating an example of a rule table according to the third example embodiment.

FIG. 12 is a flowchart illustrating an operation example of the information processing device (evaluation device) according to the third example embodiment.

FIG. 13 is a flowchart illustrating another operation example of the information processing device (evaluation device) according to the third example embodiment.

FIG. 14 is a block diagram conceptually illustrating a control configuration of an information processing device (evaluation device) according to a fourth example embodiment.

FIG. 15 is a diagram illustrating an example of a rule table according to the fourth example embodiment.

FIG. 16 is a flowchart illustrating an operation example of the information processing device (evaluation device) according to the fourth example embodiment.

FIG. 17 is a flowchart illustrating another operation example of the information processing device (evaluation device) according to the fourth example embodiment.

FIG. 18 is a block diagram conceptually illustrating a control configuration of an information processing device (evaluation device) according to a fifth example embodiment.

FIG. 19 is a diagram illustrating an example of a rule table according to the fifth example embodiment.

FIG. 20 is a flowchart illustrating an operation example of the information processing device (evaluation device) according to the fifth example embodiment.

FIG. 21 is a flowchart illustrating another operation example of the information processing device (evaluation device) according to the fifth example embodiment.

FIG. 22 is a block diagram conceptually illustrating a control configuration of an information processing device (evaluation device) according to a sixth example embodiment.

FIG. 23 is a diagram illustrating an example of a rule table according to the sixth example embodiment.

FIG. 24 is a flowchart illustrating an operation example of the information processing device (evaluation device) according to the sixth example embodiment.

FIG. 25 is a flowchart illustrating another operation example of the information processing device (evaluation device) according to the sixth example embodiment.

FIG. 26 is a diagram illustrating a modified example of a rule table.

FIG. 27 is a block diagram conceptually illustrating a control configuration of an information processing device (evaluation device) according to a third modified example.

FIG. 28 is a diagram illustrating an example of a habit database (DB).

FIG. 29 is a diagram illustrating examples of output information of a recognition unit and output information of a detection unit.

FIG. 30 is a diagram illustrating an example of information specified by a specification unit.

FIG. 31 is a diagram illustrating a rule table in a specific example.

FIG. 32 is a block diagram illustrating a modified example of a control configuration of the information processing device illustrated in FIG. 2.

FIG. 33 is a block diagram illustrating a modified example of a control configuration of the information processing device illustrated in FIG. 14.

FIG. 34 is a block diagram illustrating a modified example of a control configuration of the information processing device illustrated in FIG. 18.

### DESCRIPTION OF EMBODIMENTS

Referring to the drawings, example embodiments of the present invention will be described below.

### First Example Embodiment

An information processing device according to a first example embodiment of the present invention has a function of evaluating a conduct of a person toward another person. An evaluated person is a person a conduct of whom toward another person is evaluated. While a relation between the evaluated person and another person is not limited, it is assumed below that the evaluated person is a clerk and another person is a customer, in order to facilitate the understanding of description. In other words, the information processing device described below has a function of evaluating a conduct of a clerk toward a customer.

Device Configuration

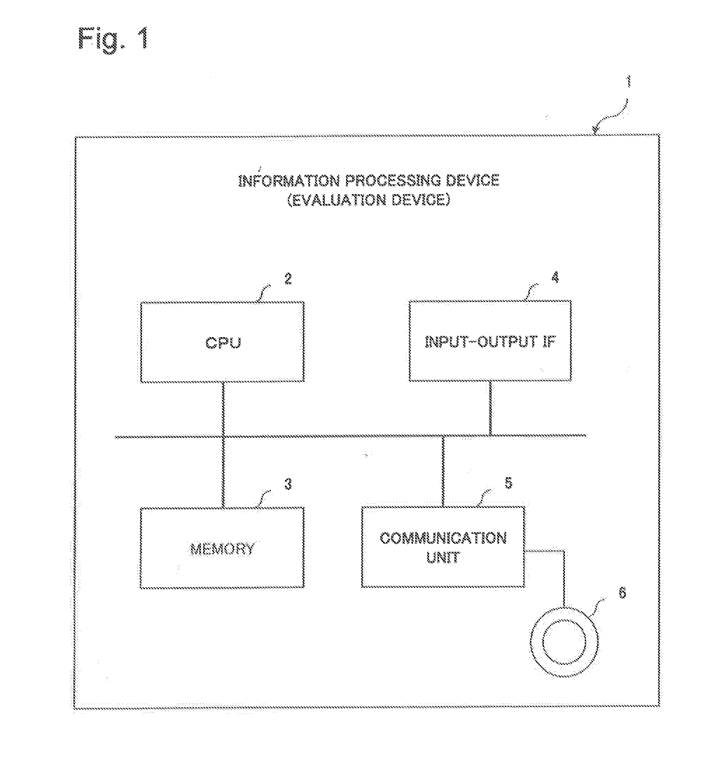

FIG. 1 is a block diagram conceptually illustrating a hardware configuration of the information processing device according to the first example embodiment. The information processing device (may be hereinafter referred to as an evaluation device) 1 according to the first example embodiment is a so-called computer and includes a central processing unit (CPU) 2, a memory 3, an input-output interface (I/F) 4, and a communication unit 5. The CPU 2, the memory 3, the input-output I/F 4, and the communication unit 5 are mutually connected by a bus.

The memory 3 is a storage device including a random access memory (RAM), a read only memory (ROM), and an auxiliary storage device (e.g. a hard disk).

The communication unit 5 has a function enabling signal exchange with another piece of equipment such as a computer. The communication unit 5 may be connected to a portable storage medium 6.

The input-output I/F 4 has a function of connecting to peripheral equipment (unillustrated) including a display device, a user interface device such as an input device, a camera, and a microphone. A display device connectable to the input-output I/F 4 is a device with a screen, such as a liquid crystal display (LCD) and a cathode ray tube (CRT) display. The display S device displays drawing data processed by the CPU 2, a graphics processing unit (GPU) (unillustrated), or the like on a screen. An input device connectable to the input-output I/F 4 is a device accepting input of a user operation, such as a keyboard and a mouse.

The evaluation device 1 may include hardware not illustrated in FIG. 1, and a hardware configuration of the evaluation device 1 is not limited to the configuration illustrated in FIG. 1. Further, the evaluation device 1 may include a plurality of CPUs 2. Thus, a number of each hardware component included in the evaluation device 1 is not limited to the example illustrated in FIG. 1.

Control Configuration

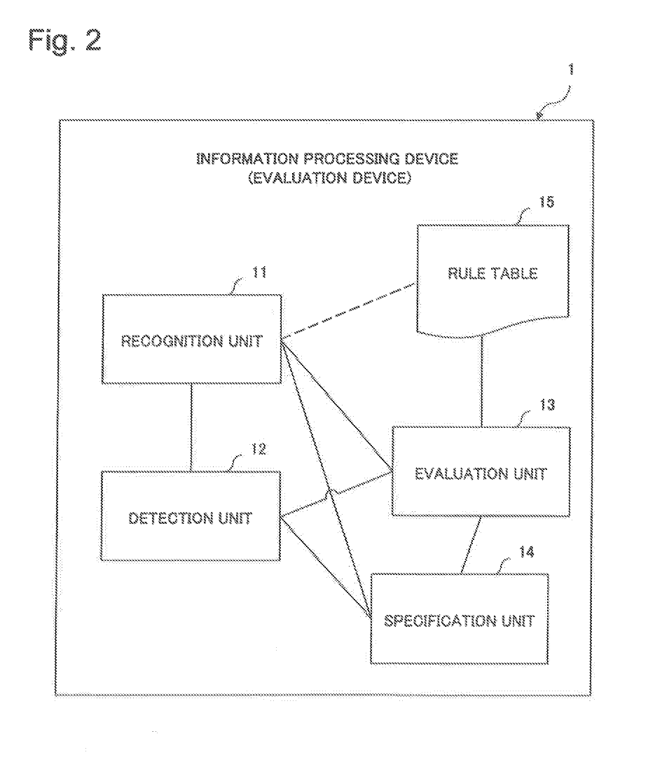

FIG. 2 is a diagram conceptually illustrating a control configuration (functional configuration) of the evaluation device 1 according to the first example embodiment. The evaluation device 1 includes, as function units, a recognition unit 11, a detection unit 12, an evaluation unit 13, and a specification unit 14. For example, each of the function units 11 to 14 is provided by the CPU 2 executing a computer program (program) stored in the memory 3. The program is acquired by the evaluation device 1 from, for example, the portable storage medium 6 such as a compact disc (CD) and a memory card. Further, the program may be acquired by the evaluation device 1 from another computer through the communication unit 5 and a network. The acquired program is stored in the memory 3. At least one of the function units 11 to 14 may be provided by a circuit using a semiconductor chip other than a CPU. Thus, a hardware configuration providing the function units 11 to 14 is not limited.

The detection unit 12 has a function of detecting a predetermined trigger state of a customer. The trigger state is one or more states of a customer by which a clerk is required to perform a certain conduct (i.e. a customer state triggering a clerk to perform a certain operation [conduct]). The trigger state of being a detecting target is predetermined. The trigger state herein is an externally distinguishable state of a person, and includes a motion, and a facial expression and a gesture that express a psychological state. Specifically, the trigger state includes, for example, states such as entering a store, waiting in a checkout line, taking out a card, looking for something, being confused, behaving suspiciously, looking delighted, and feeling rushed.

While a detecting technique by the detection unit 12 is not limited, examples thereof include a technique as follows. For example, the detection unit 12 acquires a captured image of a customer and recognizes (detects) a person and a state of the person from the acquired image using an image recognition technology. Further, the memory 3 holds reference data related to a characteristic state of a person for each trigger state to be detected. The detection unit 12 detects the trigger state of being a detecting target in a customer, based on the held reference data and the state of the person detected from the acquired image. For example, when recognizing a state of door opening and a state of a person moving into a store through the door within 3 seconds from the state, the detection unit 12 detects an “entering the store” state of a customer, being the trigger state of being a detecting target. Further, when recognizing a state of a plurality of persons not moving in from of a checkout counter for 10 seconds or more, the detection unit 12 detects a “waiting in a checkout line” state of a customer, being the trigger state of being a detecting target. Additionally, when recognizing a state of a same person standing still at one location for 15 seconds or more, the detection unit 12 detects a “confused” state of a customer being the trigger state of being a detecting target.

As another example, instead of using a captured image, the detection unit 12 may use, for example, information obtained from a human sensor to detect the trigger state of being a detecting target. The human sensor has various types such as a sensor detecting a location of a person using infrared rays, an ultrasonic wave, visible light, or the like, and a sensor detecting an action of a person based on change in an energized state in a sheet through which weak current is passing. Any type of human sensor may fee employed.

Specifically, based on information from a human sensor installed at a store, the detection unit 12 is able to detect trigger states such as “entering the store,” “leaving the store,” and “waiting in a checkout line.” When the trigger state is detected, the detection unit 12 outputs information indicating the detected trigger state and information about a detecting time thereof to the recognition unit 11 and the specification unit 14.

The recognition unit 11 recognizes a conduct of a clerk. A recognized conduct is either or both of a speech (utterance) and an action of a clerk. As a speech of a clerk, at least one item of utterance or no utterance, an utterance content, and an utterance characteristic is recognized. The utterance characteristic is a characteristic obtained from an uttered voice such as a sound level, a pitch, a tone, a pace, an emotion (e.g. delighted or sad), and an impression (e.g. a cheerful or gloomy voice tone). When an utterance characteristic is recognized, a plurality of characteristics instead of only one characteristic may be recognized as the utterance characteristic.

In other words, the recognition unit 11 recognizes only one item of or a combination of more than one items of an action of a clerk, existence of nonexistence of an utterance of a clerk, an utterance content of a clerk, and an utterance characteristic of a clerk. For example, the recognition unit 11 acquires an uttered voice of a clerk and recognizes an utterance content from the acquired uttered voice using a speech recognition technology and a natural language processing technology. Additionally, the recognition unit 11 may recognize an utterance characteristic from the acquired uttered voice along with or in place of an utterance content. For example, by an emotion recognition technology using a nonverbal feature of an utterance, the recognition unit 11 is able to acquire an utterance impression such as vigorous, cheerful, gloomy, and gentle, or an utterance emotion such as delighted, troubled, and sad. Further, by acquiring a captured image of a clerk and processing the acquired image using an image recognition technology, the recognition unit 11 may recognize an action of the clerk such as stepping up, crouching down, and bowing, based on the acquired image. An action of a clerk recognized by the recognition unit 11 is not limited to such an example.

The recognition unit 11 outputs information indicating a recognized conduct of a clerk (information about an utterance and information about an action) and information about a recognition time (detecting time) of the conduct to the evaluation unit 13 and the specification unit 14.

A clerk and a customer can be distinguished by various methods. For example, the recognition unit 11 and the detection unit 12 distinguish a clerk from a customer by respectively processing different data media. Specifically, the detection unit 12 uses image data capturing an image of a customer, and the recognition unit 11 uses voice data obtained from a microphone attached to a clerk. Further, the recognition unit 11 and the detection unit 12 may respectively use images captured by different cameras. When same image data are used, the recognition unit 11 and the detection unit 12 recognize a clerk by recognizing a face, clothing, and an accessory (including a name tag) of the clerk based on previously given feature information of the clerk, by an image recognition technology, and recognize any other person as a customer. The recognition unit 11 and the detection unit 12 may thus distinguish a customer from a clerk.

There may be more than one clerks being evaluated persons. The recognition unit 11 is able to recognize a face, clothing, an accessory (including a name tag), and the like of a clerk from a captured image by using an image recognition technology, and distinguish each clerk, from one piece of image data, based on the recognized information and feature information previously given for each clerk. Further, when a plurality of cameras capturing images of respective clerks are provided, the recognition unit 11 is able to distinguish each clerk by a captured image output from each camera. When a microphone is attached to each clerk, the recognition unit 11 is able to distinguish each clerk by distinguishing a microphone outputting voice data. Further, when information from a point of sale (POS) terminal or a FOS system (hereinafter collectively referred to as a POS device), the recognition unit 11 is able to acquire an identification (ID) of a logged-in clerk from the POS device.

The recognition unit 11 may successively recognize every conduct performed by a clerk, or may only recognize a predetermined evaluation target conduct (hereinafter also referred to as a designated conduct) of the clerk specified based on the trigger state of a customer detected by the detection unit 12. In this case, for example, reference information indicating a designated conduct of a clerk associated with the trigger state of a customer is held in the memory 3. Then, after the trigger state of a customer is detected by the detection unit 12, the recognition unit 11 specifies (recognizes) a designated conduct associated with the detected trigger state of the customer from reference information indicating a designated conduct of a clerk. Additionally, the recognition unit 11 recognizes a designated conduct of a clerk by determining whether or not the clerk performs a specified designated conduct. Thus, when the recognition unit 11 recognizes a designated conduct of a clerk, the specification unit 14 described below may be omitted.

By using either or both of time information and positional information, the specification unit 14 specifies a conduct of a clerk (i.e. an evaluation target conduct) related to the trigger state of a customer detected by the detection unit 12, out of conducts of the clerk recognized by the recognition unit 11. There may be one or more than one conducts to be specified. For example, based on time information on the trigger state of a customer detected by the detection unit 12 and time information on a conduct of a clerk recognized by the recognition unit 11, the specification unit 14 specifies a conduct of the clerk dealing with the detected trigger state of the customer, out of the recognized conducts of the clerk. For example, the specification unit 14 determines, as an evaluation target conduct, a conduct of a clerk performed within a predetermined time range before and after a detecting time of the trigger state of a customer.

Further, the specification unit 14 may specify a conduct of an evaluated clerk by using positional information of a customer the trigger state of whom is detected by the detection unit 12 and positional information of a clerk a conduct of whom is recognized by the recognition unit 11. In this case, the specification unit 14 specifies, as an evaluation target conduct, a conduct of a clerk closer to the customer the trigger state of whom is detected.

There are various techniques of detecting (grasping) a positional relation between a clerk and a customer, and any technique may be adopted. For example, when a customer the trigger state of whom is detected and a clerk appear in a captured image, the specification unit 14 is able to grasp a positional relation between the clerk and the customer in the captured image, based on the positions thereof in the image. Then, the specification unit 14 specifies, as the evaluated person, a clerk closest to the customer the trigger state of whom is detected, in the image. Alternatively, the specification unit 14 may grasp a position of a clerk or a customer by an installation position of a camera capturing an image of the clerk or the customer. Further, when a customer or a clerk is recognized by using a sensor, the specification unit 14 may grasp a position of the customer or the clerk based on information about an installation position of the sensor. Furthermore, a global positioning system (GPS) receiver may be attached to each clerk, and the specification unit 14 may grasp a position of a clerk based on positional information from the GPS receiver. Since a technique using GPS-based positional information is able to detect a position of a clerk with high precision, even when there are a plurality of clerks being potential evaluated persons, the specification unit 14 is able to specify a conduct of at least one clerk evaluated with respect to a detected trigger state of a customer.

The evaluation unit 13 evaluates a conduct of a clerk. For example, the evaluation unit 13 evaluates a conduct of a clerk by checking a designated action of a clerk determined based on the trigger state of a customer detected by the detection unit 12 against an evaluation target conduct of a clerk specified by the specification unit 14. As an evaluation result, the evaluation unit 13 may determine a two-level (e.g. “good” and “poor”) evaluation result, or may determine a rating with three levels or more (e.g. “good,” “poor,” and “average”). The checking of an evaluation target conduct of a clerk against a designated conduct by the evaluation unit 13 may be performed by comparison between text data, comparison between ID data such as an action ID, or comparison between phoneme data.

A conduct of a clerk may be proper even when the conduct does not completely match a predetermined designated conduct due to difference in an end of a sentence or an expression. Accordingly, the evaluation unit 13 may calculate a degree of matching (similarity) by checking a recognized evaluation target conduct against a designated conduct, and determine whether or not a clerk performs the designated conduct, based on whether or not the degree of matching Is within an acceptable limit.

The designated conduct of a clerk is a recommended conduct expected of a clerk depending on a customer state, and is set based on a customer state detected by the detection unit 12. Specifically, when an utterance content or an utterance characteristic of a clerk is recognized by the recognition unit 11, a predetermined utterance content or a predetermined utterance characteristic is set as a designated conduct. In this case, the evaluation unit 13 evaluates a conduct of a clerk based on an utterance content or an utterance characteristic, being a designated conduct of the clerk, the conduct being related to the trigger state of a customer detected by the detection unit 12, and an evaluation target conduct of the clerk specified by the specification unit 14.

When a plurality of conducts (an utterance content, an utterance characteristic, and an action) are specified as designated conducts, the evaluation unit 13 may determine a rating with three levels or more depending on a number of times a conduct is performed by a clerk, out of the plurality of specified designated conducts. Additionally, the evaluation unit 13 may determine a rating as follows. For example, it is assumed that each of an utterance content, an utterance characteristic, and an action as designated conducts is gives a rating or priority depending on a degree of influence on a customer. In this case, the evaluation unit 13 determines a final rating by using a rating or priority given to a designated conduct related to an evaluation target conduct of a clerk.

When the recognition unit 11 recognizes whether a designated conduct is performed by a clerk, the evaluation unit 13 evaluates a conduct of the clerk using a recognition (determination) result by the recognition unit 11 instead of Information from the specification unit 14.

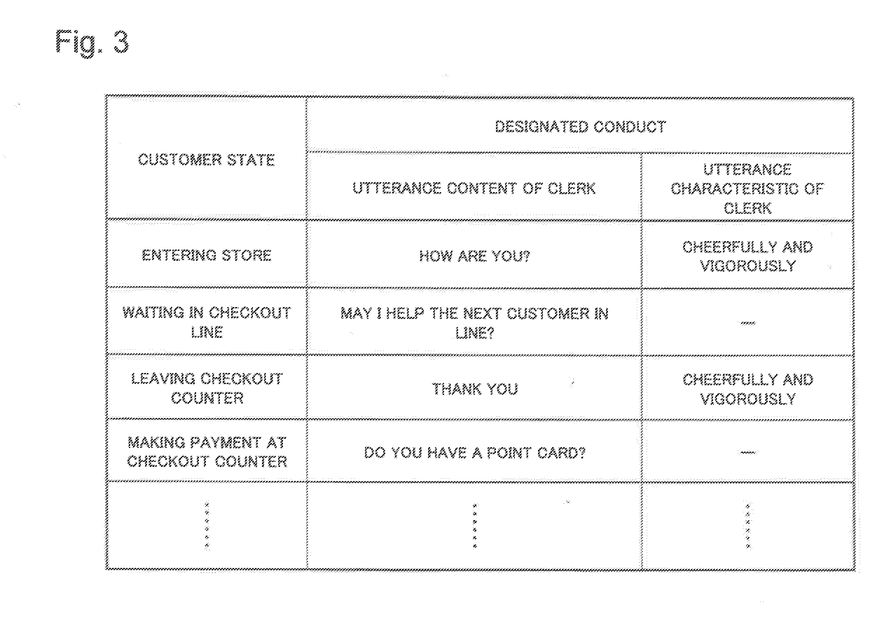

A specific example of an evaluation technique by the evaluation unit 13 will be described. For example, the evaluation unit 13 specifies a designated conduct based on a rule table 15. FIG. 3 is a diagram illustrating an example of the rule table 15 according to the first example embodiment. The rule table 15 illustrated in FIG. 3 contains tabular data associating a state of a customer (trigger state) with a designated conduct expected of a clerk (recommended conduct) when the state of the customer occurs. In the example in FIG. 3, an utterance content and an utterance characteristic are set as designated conducts of a clerk. Specifically, with respect to a customer state “entering the store,” the rule table 15 stores “How are you?” as an utterance content being a designated conduct, and “cheerfully and vigorously” as an utterance characteristic being a designated conduct, in a mutually associated manner. Further, with respect to a customer state “in a checkout line,” the rule table 15 stores only “May I help the next customer in line?” as an utterance content being a designated conduct in a mutually associated manner.

While data indicating a customer state and a designated conduct of a clerk are expressed by character strings in FIG. 3 for convenience of facilitating description, the data may be expressed by numerical values. Further, while not illustrated in FIG. 3, the rule table 15 may include an evaluation value further associated with data associating a customer state with a designated conduct of a clerk. Further, when a plurality of designated conducts are associated with one customer state, a rating may be associated with each designated conduct. For example, when an utterance content and an utterance characteristic are set as designated conducts, a rating of the utterance content “How are you?” may be set to 60 points and a rating of the utterance characteristic “cheerfully and vigorously” to 40 points. While the example in FIG. 3 indicates an utterance content and an utterance characteristic as designated conducts, the designated conducts are not limited thereto.

The evaluation unit 13 specifies a designated conduct of a clerk, the conduct being related to a detected trigger state in a customer, based on information stored in the rule table 15. For example, a specified designated conduct of a clerk is at least one item of any utterance, an utterance content, an utterance characteristic, and an action. The evaluation unit 13 evaluates a conduct of a clerk by checking an evaluation target conduct of a clerk specified by the specification unit 14 against a designated conduct of a clerk specified by the recognition unit 11.

When the recognition unit 11 recognizes (determines) whether or not a designated conduct of a clerk specified based on the trigger state of a customer detected by the detection unit 12, the recognition unit 11 refers to the rule table 15. For example, when the trigger state of a customer is detected by the detection unit 12, the recognition unit 11 specifies a designated conduct of a clerk, the conduct being related to the detected trigger state, by referring to the rule table 15. The recognition unit 11 determines whether the clerk (the clerk specified by the specification unit 14) performs the specified designated conduct, and the evaluation unit 13 evaluates the conduct of the clerk based on the result.

Operation Example (Conduct Evaluation Method)

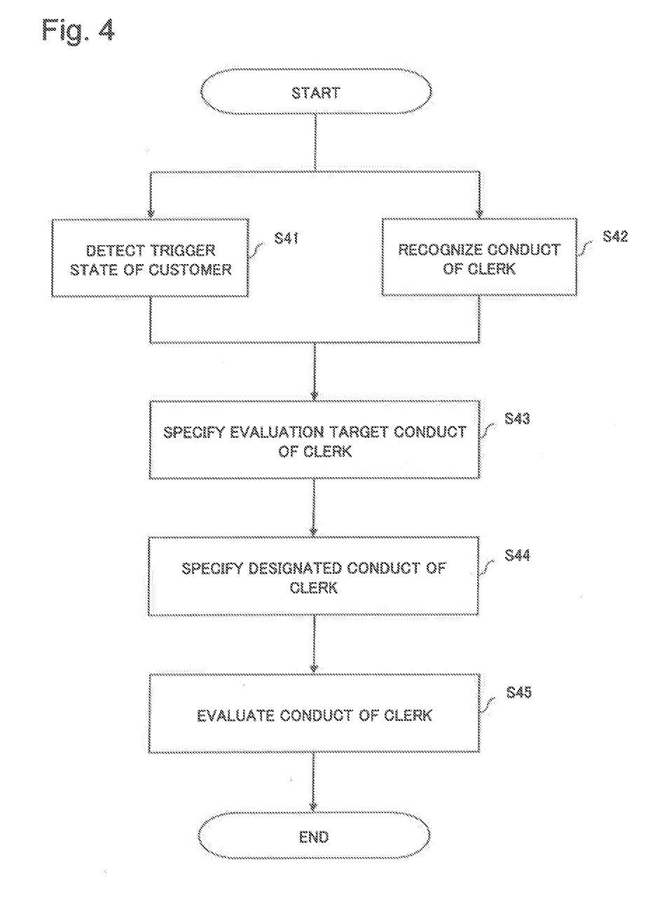

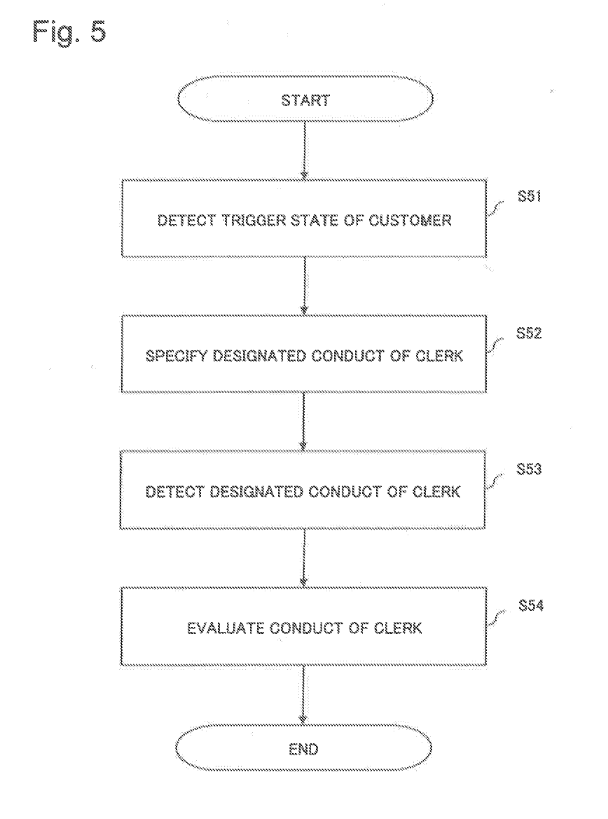

FIGS. 4 and 5 are flowcharts illustrating operation examples (processing procedures) of the evaluation device 1 according to the first example embodiment.

In the processing procedure illustrated in FIG. 4, the detection unit 12 in the evaluation device 1 first detects the trigger state of a customer (S41). Further, the recognition unit 11 recognizes a conduct of a clerk (S42). For example, the detection unit 12 detects a predetermined trigger state (e.g. entering the store or leaving the store) related to a customer (S41), while the recognition unit 11 appropriately recognizes at least either of an utterance content and an utterance characteristic of a clerk (S42).

When the trigger state of a customer is detected, the specification unit 14 specifies an evaluation target conduct of a clerk. The conduct is related to the detected trigger state of the customer (S43). For example, the specification processing is performed using time information of the trigger state of the customer detected by the detection unit 12 and time information of a conduct of a clerk recognized by the recognition unit 11. The specification processing may be performed by further using positional information of the customer the trigger state of whom is detected and positional information of the clerk the conduct of whom is recognized.

Subsequently, the evaluation unit 13 specifies a designated conduct of the clerk. The conduct is related to the detected trigger state of the customer, by, for example, referring to the rule table 15 (S44).

Then, the evaluation unit 13 checks the specified designated conduct against the conduct of the clerk being an evaluation target, and evaluates the conduct of the clerk based on conformity obtained by the checking (S45).

FIG. 5 illustrates an example of a processing procedure different from the processing procedure illustrated in FIG. 4. Specifically, the processing procedure in FIG. 5 is a processing procedure not requiring processing related to the specification unit 14. In the processing procedure in FIG. 5, the detection unit 12 in the evaluation device 1 detects the trigger state of a customer (S51), and the recognition unit 11 subsequently specifies a designated conduct of a clerk. The conduct is related to the detected trigger state, by referring to the rule table 15 (S52).

Subsequently, the recognition unit 11 determines whether the conduct recognized as a conduct of the clerk is a designated conduct (S53). Then, the evaluation unit 13 evaluates the conduct of the clerk in accordance of the determination result (recognition result) (S54).

When there are a plurality of clerks being potential evaluated persons, for example, the recognition unit 11 acquires positional information of the customer the trigger state of whom is detected, and specifies a clerk being an evaluation target, based on the positional information. Then, the evaluation unit 13 evaluates the conduct of the specified clerk being an evaluation target, similarly to the above.

The processing procedures performed by the evaluation device 1 according to the first example embodiment are not limited to the examples in FIGS. 4 and 5. For example, the processing of specifying an evaluation target conduct (S43 in FIG. 4) and the processing of specifying a designated conduct (S44) may be performed in parallel. Alternatively, the processing of specifying a designated conduct (S44) may be performed before the processing of specifying an evaluation target conduct (S43).

Effect of First Example Embodiment

As described above, according to the first example embodiment, the trigger state of a customer is detected, and a conduct of a clerk Is recognized. Then, the conduct of the clerk is evaluated based on a result of whether the clerk performs a designated conduct (recommended conduct) expected of the clerk in accordance the detected trigger state of the customer. Thus, in addition to utterance contents of a clerk and a customer, the first example embodiment evaluates a conduct of the clerk based on the trigger state of the customer, and therefore is able to properly evaluate a conduct of the clerk toward the customer.

Further, the evaluation device 1 according to the first example embodiment may have a configuration in which a conduct of a clerk is evaluated in consideration of an utterance characteristic being a designated conduct related to a detected trigger state of a customer. In this case, for example, the evaluation device 1 is able to evaluate a conduct of a clerk based on an index (designated conduct) such as giving some utterance in a cheerful and vigorous voice or give an utterance “How are you?” in a cheerful and vigorous voice. In other words, the evaluation device 1 is able to perform an evaluation based on an index different from that in a case of evaluating a conduct of a clerk based on an utterance content.

Further, the evaluation device 1 according to the first example embodiment includes a component (specification unit 14) capable of specifying an evaluation target conduct of a clerk using either or both of time information and positional information. Consequently, the evaluation device 1 is able to properly evaluate a conduct of a clerk even when there are a plurality of clerks being potential evaluated persons, or a conduct of a clerk is continuously recognized.

Specific examples of conducts (indices [designated conducts]) of a clerk that can be evaluated by the evaluation device 1 according to the first example embodiment will be described. The designated conducts are not limited to the following specific examples.

Index (Designated Conduct [Recommended Conduct]):

When a customer enters a store, a clerk says “How are you?” (utterance content) cheerfully and vigorously (utterance characteristic),

When a checkout line is formed, a clerk says “Thank you for waiting.” (utterance content).

When a customer takes out a card at a checkout counter, a clerk says “Are you OK to pay by electronic money?” (utterance content).

When a customer stands in front of a checkout counter to make a payment, a clerk bows with a smile.

When a customer looks confused, a clerk approaches the customer (action) and says “Can I help you find something??” (utterance content).

The detection unit 12 is able to detect a state of a customer taking out a card (holding a card in a hand) at a checkout counter as follows. Specifically, the detection unit 12 is able to recognize a customer's hand by image-processing a captured image of a checkout counter and a surrounding area, and detect a state of the customer taking out a card at the checkout counter, by recognizing a rectangular object around the hand.

Further, the detection unit 12 is able to detect a state of a customer standing in front of a checkout counter, based on a captured image or a sensor output that is output from a human sensor. Additionally, the detection unit 12 is able to recognize a face (contour) and a facial expression by image-processing a captured image of a clerk, and detect a smile of the clerk based on the recognition result. Furthermore, the detection unit 12 is able to recognize a change (movement) of a person and a human shape by image-processing a captured image of a clerk, and detect an action (e.g. bowing and an action of approaching a customer) of the clerk based on the recognition result.

### Second Example Embodiment

A second example embodiment of the present invention will be described below.

In addition to the information used by the first example embodiment, an evaluation device 1 according to the second example embodiment uses attribute information of a customer in evaluation of a conduct of a clerk. In description of the second example embodiment, a same reference sign is given to a component with a same designation as a component constituting the evaluation device 1 according to the first example embodiment, and redundant description of the common part is omitted.

Control Configuration

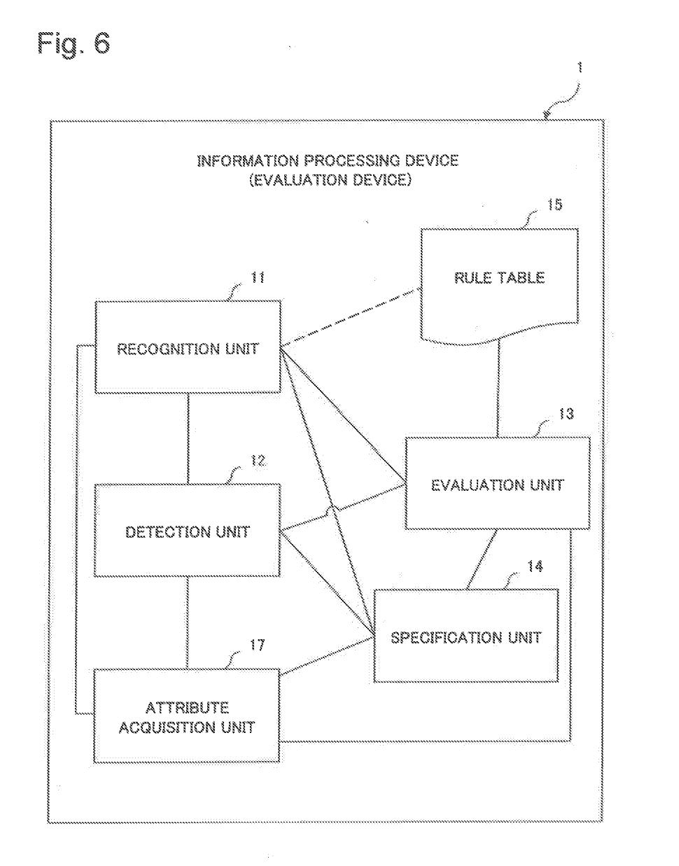

FIG. 6 is a block diagram conceptually illustrating a control configuration in the evaluation device 1 according to the second example embodiment. In addition to the control configuration according to the first example embodiment, the evaluation device 1 according to the second example embodiment further includes an attribute acquisition unit 17. For example, the attribute acquisition unit 17 is provided by a CPU.

The attribute acquisition unit 17 acquires attribute information of a customer the trigger state of whom is detected by a detection unit 12. The attribute information is information indicating a feature of a customer, and is, for example, information including at least one of an age group, a gender, and a nationality. For example, the attribute acquisition unit 17 acquires a captured image from which the trigger state of a customer is detected by the detection unit 12, and extracts a feature of the face of the customer from the acquired captured image by using an image recognition technology. Then, the attribute acquisition unit 17 acquires attribute information on the customer using the extracted feature of the face. The attribute acquisition unit 17 may perform learning of feature data of an image in order to extract attribute information on a customer with high precision from the image. Further, information about an age of a customer may be information about an age group (generation) such as below ten, teens, twenties, thirties, and forties.

Further, for example, some type of POS device has a function of having an operator input feature information of a customer such as an age group and a gender upon payment. When such a type of POS device is used, the attribute acquisition unit 17 is able to acquire attribute information of a customer from the POS device. Thus, attribute information acquisition techniques include various techniques, and a suitable technique considering a situation and the like of a store at which the evaluation device 1 is used is adopted.

The trigger state of a customer detected by the detection unit 12 is associated with attribute information of the customer acquired by the attribute acquisition unit 17 by, for example, a specification unit 14. The association technique may be provided by various techniques. For example, when acquisition source data of the trigger state of a customer and acquisition source data of attribute information on the customer are same data such as same image data, the acquired trigger state is associated with the acquired attribute information.

Further, acquisition source data may differ such as a case that either type of acquisition source data of the trigger state in a customer and attribute information of the customer are image data, and the other type of acquisition source data are an output of a sensor. In this case, the specification unit 14 associates the trigger state with attribute information with respect to a same customer by using time information, or time information and positional information of each piece of data. In this case, the attribute acquisition unit 17 acquires attribute information on the customer and, at the same time, acquires time information of the acquired attribute information. The time information of attribute information may be information indicating an acquisition time of the attribute information or information indicating an acquisition time of acquisition source data of the attribute information by an imaging device or a POS device. Further, the detection unit 12 detects the trigger state of a customer and, at the same time, acquires time information of the trigger state. The time information of the trigger state may be information indicating a detecting time of the trigger state or information indicating an acquisition time of data used for detecting the trigger state by an imaging device or the like.

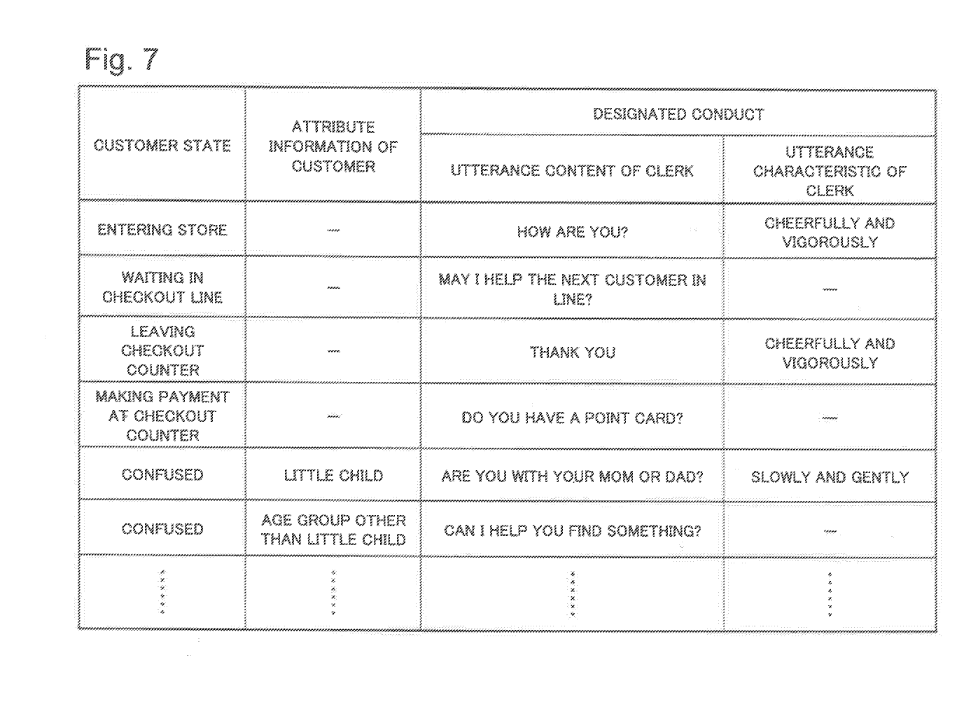

FIG. 7 is a diagram illustrating an example of a rule table 15 according to the second example embodiment. The rule table 15 according to the second example embodiment stores relation data associating a customer state with attribute information of the customer and a designated conduct (an utterance content and an utterance characteristic) of a clerk. In FIG. 7, a part to which attribute information of a customer is not set and a part to which an utterance characteristic of a clerk being a designated conduct is not set are marked with a symbol “-.”

In the example in FIG. 7, when a customer state (trigger state) is “confused” and attribute information of the customer is a “little child,” the customer is considered to be straying, and therefore an utterance content “Are you with your mom or dad?” is set as a designated conduct (recommended conduct) of a clerk. Additionally, in this case, an utterance characteristic “slowly and gently” is also set as a designated conduct (recommended conduct) of a clerk. Further, when a customer state is “confused” and attribute information of the customer is an “age group other than a little child,” an utterance content “Can I help you find something??” is set as a designated conduct of a clerk, and an utterance characteristic of a clerk is not set.

The evaluation unit 13 specifies a designated conduct of a clerk from the rule table 15 by further using attribute information of a customer the trigger state of whom is detected by the detection unit 12. The evaluation unit 13 evaluates a conduct of the clerk based on the specified designated conduct and an evaluation target conduct of the clerk recognized by the specification unit 14.

As described in the first example embodiment, the specification processing of a designated conduct may be performed by the recognition unit 11. In this case, the evaluation unit 13 determines whether the recognition unit 11 specifies a designated conduct and performs recognition processing based on the specified designated conduct. Then, when the recognition unit 11 performs the recognition processing using the designated conduct, the evaluation unit 13 evaluates a conduct of a clerk by using the recognition result by the recognition unit 11.

Operation Example (Conduct Evaluation Method)

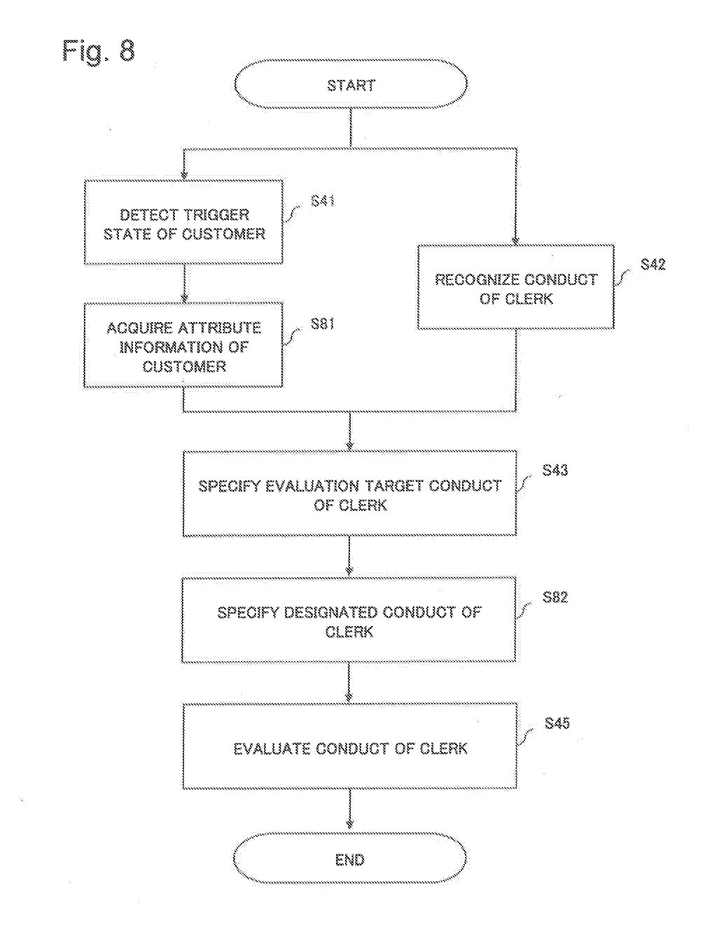

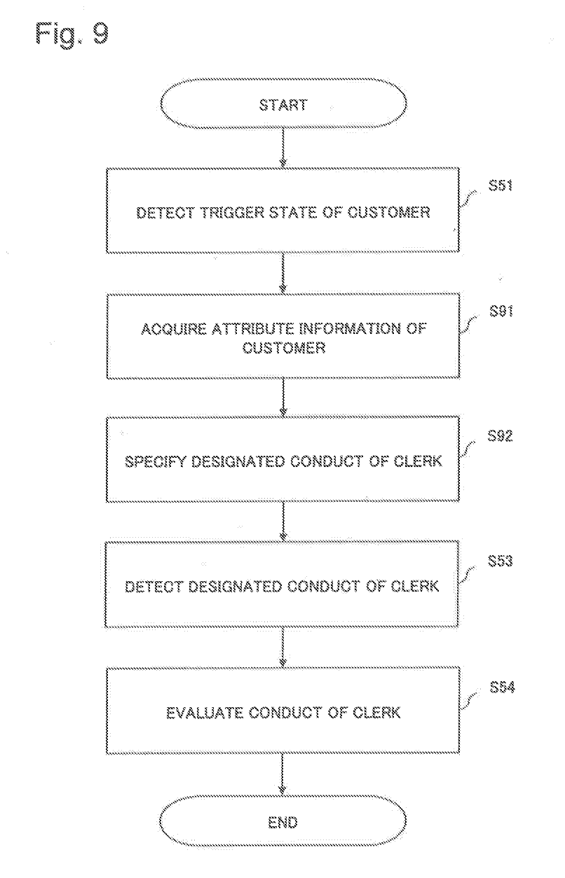

Operation examples (processing procedures) of the evaluation device 1 according to the second example embodiment will be described below by using FIGS. 8 and 9.

In FIG. 8, a same reference sign in FIG. 4 is given to same processing as that in the flowchart in FIG. 4. In the example in FIG. 8, when the detection unit 12 in the evaluation device 1 detects the trigger state of a customer (S41), the attribute acquisition unit 17 acquires attribute information of the customer the trigger state of whom is detected (S81). Further, the recognition unit 11 recognizes a conduct of a clerk (S42).

Subsequently, the specification unit 14 specifies an evaluation target conduct of the clerk, the conduct being related to the detected trigger state of the customer (S43). Then, the evaluation unit 13 specifies a designated conduct of the clerk from the rule table 15, based on the detected trigger state of the customer and the acquired attribute information of the customer (S82). Subsequently, the evaluation unit 13 cheeks the specified designated conduct against the evaluation target conduct of the clerk, and evaluates the conduct of the clerk based on conformity obtained by the checking (S45).

In FIG. 9, a same reference sign in FIG. 5 is given to same processing as that in the flowchart in FIG. 5. In the example in FIG. 9, when the detection unit 12 in the evaluation device 1 detects the trigger state of a customer (S51), the attribute acquisition unit 17 acquires attribute information of the customer the trigger state of whom is detected (S91). Subsequently, the recognition unit 11 specifies a designated conduct of a clerk, the conduct being related to the detected trigger state of the customer, from the rule table 15, based on the detected trigger state of the customer and the attribute information of the customer (S92). Then, the recognition unit 11 determines (detects) whether or not the clerk performs the specified conduct (S53). The evaluation unit 13 evaluates the conduct of the clerk based on the determination result (S54).

Effect of Second Example Embodiment

The evaluation device 1 according to the second example embodiment further acquires attribute information of a customer the trigger state of whom is detected, and specifies a designated conduct of a clerk based on the detected trigger state of the customer and the attribute information of the customer. Then, the evaluation device 1 according to the second example embodiment evaluates a conduct of the clerk by using the specified designated conduct. Specifically, the evaluation device 1 according to the second example embodiment evaluates the conduct of the clerk with an index of whether or not the clerk performs the designated conduct conforming to the trigger state and the attribute information of the customer. In other words, the evaluation device 1 according to the second example embodiment is able to set a designated conduct more suited to a customer, and therefore is able to more minutely evaluate a conduct of a clerk toward the customer.

Specific examples of conducts (indices [designated conducts]) of a clerk that can be evaluated by the evaluation device 1 according to the second example embodiment will be described. The designated conducts are not limited to the following specific examples.

Index (Designated Conduct):

When there is a customer being a stray child (a customer state being “confused” and attribute information of the customer being a “little child”), a clerk says “Are you with your mom or dad?” (utterance content) “slowly and gently” (utterance characteristic).

When there is a customer being a stray child (a customer state being “confused” and attribute information of the customer being a “little child”), a clerk approaches the customer and speaks in a crouching state.

When there is a confused customer other than a little child (attribute information of the customer being “other than a little child” and a customer state being “confused”), a clerk approaches the customer (action) and says “Can I help you find something??” (utterance content).

The detection unit 12 is able to detect an utterance characteristic “slowly” by measuring a pitch (pace) of an utterance. Further, the detection unit 12 is able to detect a confused state of a customer by a facial expression recognition technology using image processing of a captured image of the customer. Further, the detection unit 12 is also able to detect a confused state of a customer based on a motion of a person such as wandering around in a store. Additionally, the detection unit 12 is able to detect a crouching state of a clerk by a recognition technology of a human shape using image processing of a captured image of the clerk. Furthermore, the detection unit 12 is able to detect a motion of a clerk speaking to someone by image processing instead of existence or nonexistence of voice.

### Third Example embodiment

A third example embodiment of the present invention will be described below. In description of the third example embodiment, a same reference sign is given to s component with a same designation as a component constituting the evaluation device 1 according to the first and second example embodiments, and redundant description of the common part is omitted.

Control Configuration

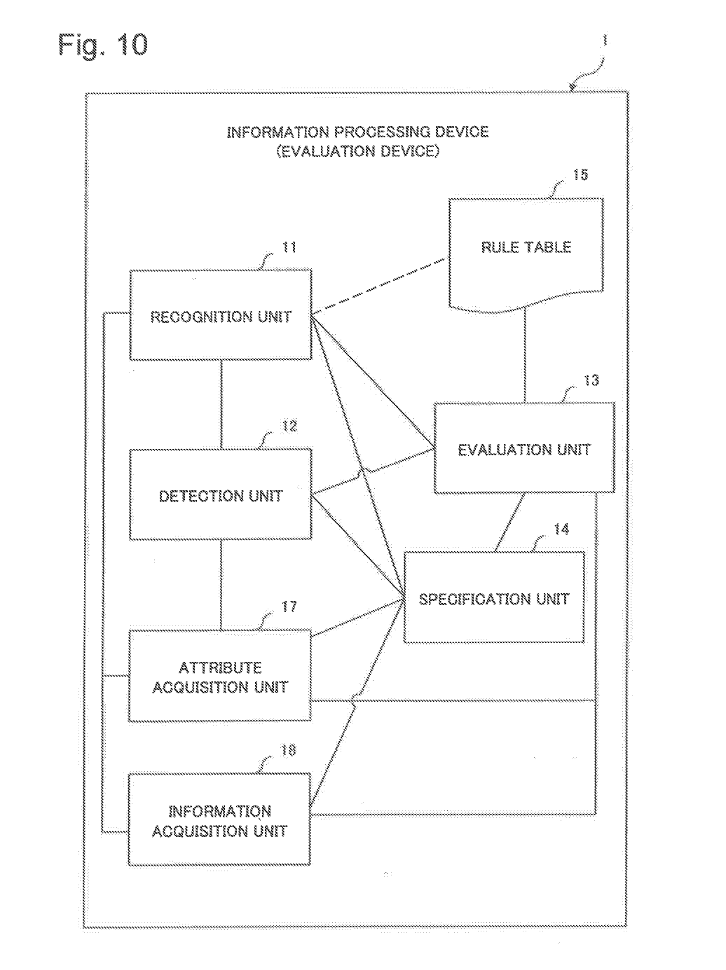

FIG. 10 is a block diagram conceptually Illustrating a control configuration in an evaluation device 1 according to the third example embodiment. The evaluation device 1 according to the third example embodiment evaluates a conduct of a clerk using information of a target commodity to be purchased by a customer in evaluation of the conduct of the clerk, in addition to the trigger state of the customer and attribute information of the customer. Specifically, the evaluation device I according to the third example embodiment includes an information acquisition unit 18 in addition to the configuration according to the second example embodiment. The information acquisition unit 18 is provided by a CPU.

The information acquisition unit 18 acquires information about a target commodity purchased by a customer. For example, the information acquisition unit 18 uses information in a POS device in order to acquire information about a commodity being a purchase target. In this case, the information acquisition unit 18 may acquire a commodity identification code read from a bar code of the commodity by the POS device, or may acquire information specified by the commodity identification code, such as a commodity name. Further, the information acquisition unit 18 may acquire information about a commodity identification code from a POS device every time a POS device reads the information, or may acquire information about a plurality of target commodities collectively from the POS device. Additionally, the information acquisition unit 18 may acquire information such as ID data of a clerk logging into a POS device from the POS device, in addition to information about a target commodity. Further, the information acquisition unit 18 may acquire information about a target commodity by image-processing a captured image of a customer and detecting the commodity from the captured image, instead of information from a POS device.

In third example embodiment, it is necessary that target commodity information acquired by the information acquisition unit 18 is associated with information about the trigger state of a customer detected by the detection unit 12 and attribute information acquired by the attribute acquisition unit 17. The association techniques of the information include various techniques. For example, when data on which each type of information is based are same data (e.g. same image data or data obtained from a same POS device), information about the trigger state of a customer acquired from the same data is associated with attribute information and target commodity information, being acquired from the same data.

Further, when data on which information about the trigger state of a customer, attribute information, and target commodity information are based are different, for example, the specification unit 14 associates the information with each other by using acquired time information, acquired positional information, and the like of each type of data. In this case, the information acquisition unit 18 acquires lime information of a target commodity along with information about the target commodity. The time information of the target commodity refers to a time when the target commodity is recognized.

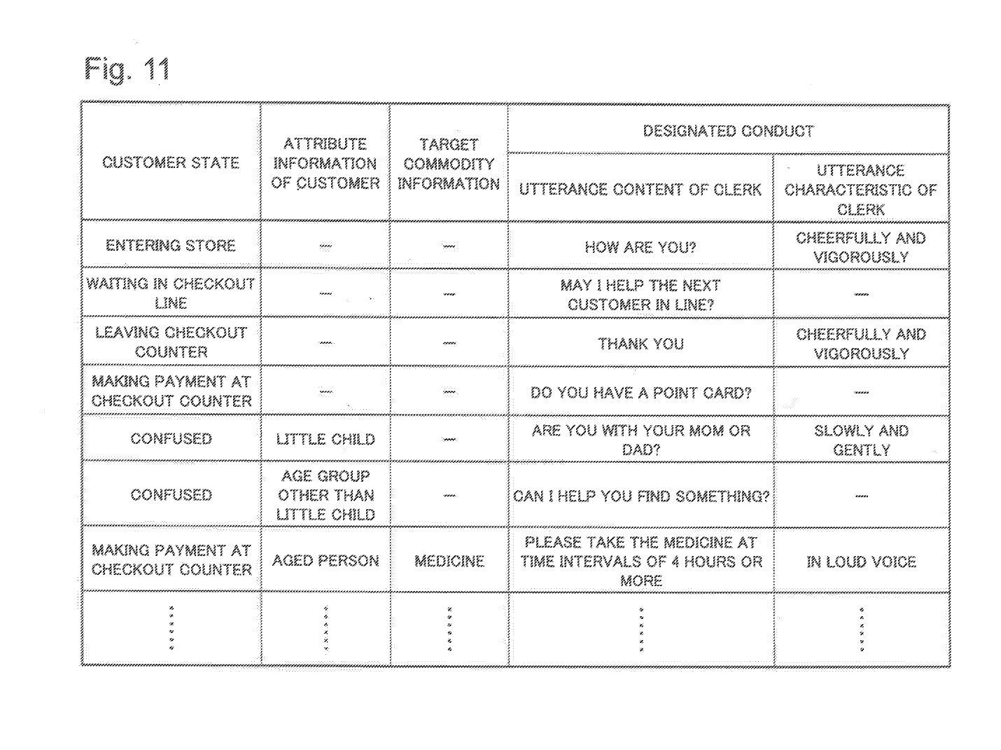

FIG. 11 is a diagram illustrating an example of a rule table 15 according to the third example embodiment. The rule table 15 according to the third example embodiment stores relation data associating a customer state with attribute information of the customer, target commodity information, and a designated conduct of a clerk. In FIG. 11, a part to which information is not set is marked with a symbol “-.”

In the example in FIG. 11, when a customer state (trigger state) is “making a payment at a checkout counter,” attribute information of the customer is an “aged person,” and target commodity information is “medicine,” an utterance content “Please take the medicine at time intervals of 4 hours or more” is set as a designated conduct of a clerk. Further, in this case, an utterance characteristic “in a loud voice” is set as a designated conduct of a clerk. The state of a customer making a payment at a checkout counter (trigger state), the customer being an aged person (attribute information), and the purchased commodity being medicine (target commodity) can be respectively detected from a captured image of the customer by image-processing the captured image.

In addition to information about the trigger state detected by the detection unit 12, an evaluation unit 13 specifies a designated conduct (recommended conduct) of a clerk from the rule table 15 by further using attribute information of a customer the trigger state of whom is detected and commodity information of a purchase target. The processing may be performed by a recognition unit 11. In this case, the evaluation unit 13 determines whether or not the recognition unit 11 specifies a designated conduct and, when the recognition unit 11 performs recognition processing based on the designated conduct, evaluates the conduct of the clerk by using the recognition processing result by the recognition unit 11.

Operation Example

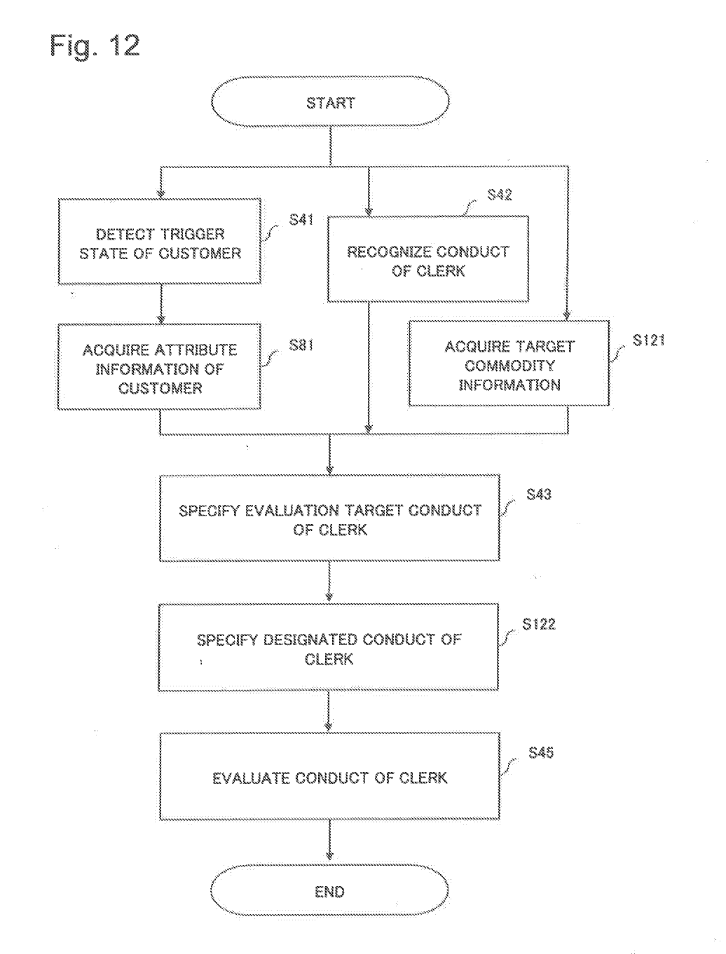

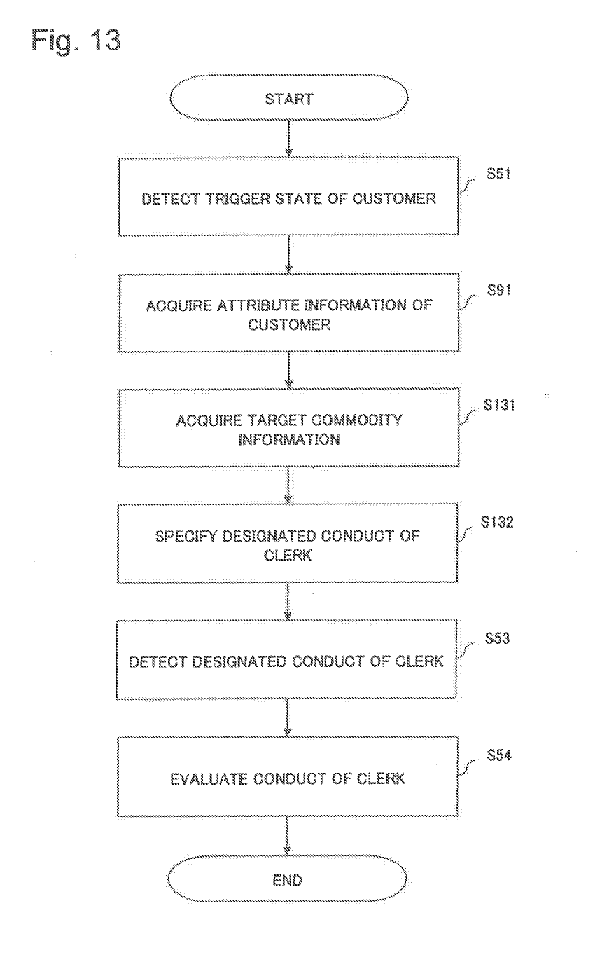

Operation examples of the evaluation device 1 according to the third example embodiment will be described below by using FIGS. 12 and 13. FIGS. 12 and 13 are flowcharts illustrating operation examples (processing procedures) of the evaluation device 1 according to the third example embodiment. In FIG. 12, a same reference sign in FIG. 8 is given to same processing as that in the flowchart in FIG. 8. Further, in FIG. 13, a same reference sign in FIG. 9 is given to same processing as that in the flowchart in FIG. 9.

In the example in FIG. 12, when the detection unit 12 in the evaluation device 1 detects the trigger state of a customer (S41), the attribute acquisition unit 17 acquires attribute information of the customer the trigger state of whom is detected (S81). Further, the recognition unit 11 recognizes a conduct of a clerk (S42). Additionally, the information acquisition unit 18 acquires commodity information about a purchase target of the customer (S121). Then, the specification unit 14 associates the information about the trigger state with the attribute information and the commodity information about the purchase target, with respect to the same customer.

Subsequently, the specification unit 14 specifies an evaluation target conduct of the clerk, the conduct being related to the detected trigger state of the customer (S43). Then, the evaluation unit 13 specifies a designated conduct of the clerk from the rule table 15, based on the detected trigger state of the customer, the acquired attribute information of the customer, and the acquired commodity information about the purchase target (S122). Subsequently, the evaluation unit 13 checks the specified designated conduct against the evaluation target conduct of the clerk, and evaluates the conduct of the clerk using the conformity determination result by the checking (S45).

In the example in FIG. 13, when the detection unit 12 in the evaluation device 1 detects the trigger state of a customer (S51), the attribute acquisition unit 17 acquires attribute information of the customer the trigger state of whom is detected (S91). Further, the information acquisition unit 18 acquires commodity information about a purchase target of the customer (S131). Subsequently, the recognition unit 11 specifies a designated conduct of a clerk, the conduct being related to the trigger state of the customer, from the rule table 15, based on the detected trigger state of the customer, the attribute information of the customer, and the commodity information about the purchase target (S132). Then, the recognition unit 11 determines (detects) whether the clerk performs the specified designated conduct (S53), and the evaluation unit 13 evaluates the conduct of the clerk based on the determination result (S54).

Effect of Third Example Embodiment

The evaluation device 1 according to the third example embodiment also acquires information about a target commodity to be purchased by a customer the trigger state of whom is detected, and specifies a designated conduct of a clerk based on the obtained trigger state of the customer, attribute information, and the commodity information about the purchase target. Then, the evaluation device 1 evaluates a conduct of the clerk by using the specified designated conduct. In other words, the evaluation device 1 according to the third example embodiment evaluates a conduct of the clerk by an index of whether the clerk performs a designated conduct conforming to the trigger state of the customer, the attribute information, and the commodity information about the purchase target. Accordingly, the evaluation device 1 according to the third example embodiment is able to evaluate a conduct of a clerk toward a customer based on a designated conduct (recommended conduct) set in consideration of a commodity being a purchase target of the customer.

A specific example of a conduct (index [designated conduct]) of a clerk that can be evaluated by the evaluation device 1 according to the third example embodiment will be described. The designated conduct is not limited to the following specific example.

Index (Designated Conduct):

There may be a case that a customer being an aged person is making a payment at a checkout counter, and a purchase target commodity includes medicine (customer state being “making a payment at a checkout counter,” attribute information of the customer being an “aged person,” and target commodity information being “medicine”). In this case, a clerk says “Please take the medicine at time intervals of 4 hours or more.” (utterance content) “in a loud voice” (utterance characteristic).

### Fourth Example Embodiment

A fourth example embodiment of the present invention will be described below. In description of the fourth example embodiment, a same reference sign is given to a component with a same designation as a component constituting the evaluation device according to the first to third example embodiments, and redundant description of the common part is omitted.

Control Configuration

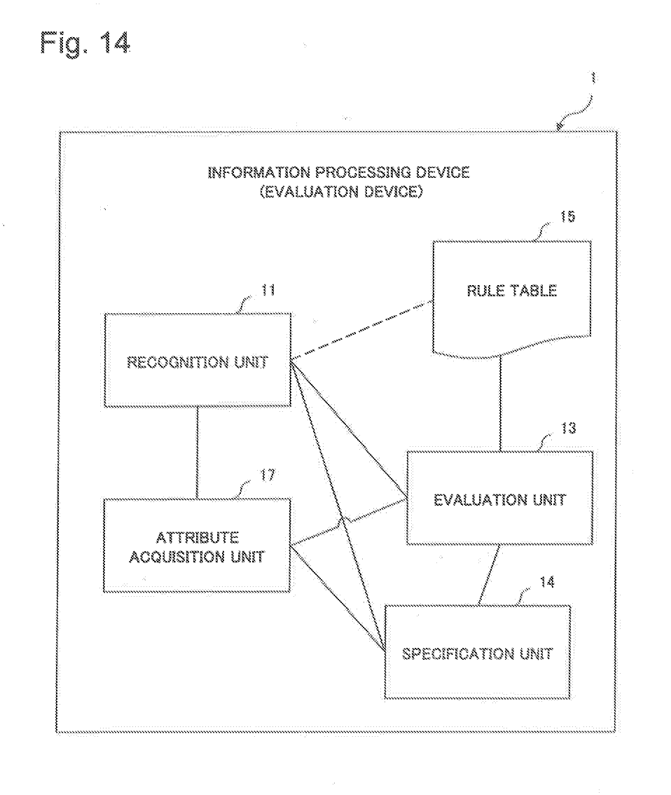

FIG. 14 is a block diagram conceptually illustrating a control configuration of an evaluation device 1 according to the fourth example embodiment. The evaluation device 1 according to the fourth example embodiment evaluates a conduct of a clerk based on attribute information of a customer, without using the trigger state of the customer or commodity information of a purchase target. Specifically, the evaluation device 1 according to the fourth example embodiment includes an attribute acquisition unit 17 in place of the detection unit 12 according to the first example embodiment.

As described in the second example embodiment, the attribute acquisition unit 17 acquires attribute information of a customer.

A specification unit 14 acquires attribute information of a customer acquired by the attribute acquisition unit 17 and time information thereof, and a conduct of a clerk recognized by a recognition unit 11 and time information thereof. Then, the specification unit 14 specifies an evaluation target conduct of the clerk, the conduct being related to the attribute information of the customer, out of the conducts of the clerk recognized by the recognition unit 11, based on the acquired time information. Alternatively, in addition to time information, the specification unit 14 also acquires positional information of the customer the attribute information of whom is acquired by the attribute acquisition unit 17 and positional information of the clerk the conduct of whom is recognized by the recognition unit 11. Then, the specification unit 14 may specify an evaluation target conduct of the clerk, the conduct being related to the attribute information of the customer, out of the recognized conducts of the clerk, based on the time information and the positional information. Alternatively, the specification unit 14 may acquire positional information of attribute information of a customer and positional information of a clerk, and specify as evaluation target conduct of the clerk by using the acquired positional information.

Thus, the specification unit 14 specifies an evaluation target conduct of a clerk, the conduct being related to attribute information of a customer, out of recognized conducts of the clerk, by using either or both of time information and positional information.

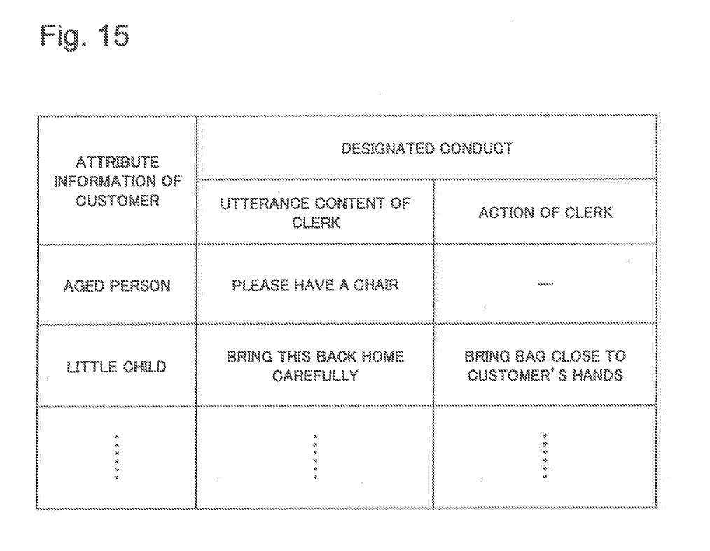

FIG. 15 is a diagram illustrating an example of a rule table 15 according to the fourth example embodiment. The rule table 15 according to the fourth example embodiment stores relation data associating attribute information of a customer with a designated conduct of a clerk. In FIG. 15, an utterance content and an action are set as designated conducts of a clerk. A part to which an action of a clerk is not set is marked with a symbol “-.”

In the example in FIG. 15, when attribute information of a customer is an “aged person,” an utterance content “Please have a chair,” is set as a designated conduct of a clerk. Further, when attribute information of a customer is a “little child,” an utterance content “Bring this back home carefully.” and an action “Bring the bag close to the customer's hands,” are set as designated conducts of a clerk.

An evaluation unit 13 specifies a designated conduct (recommended conduct) of a clerk, the conduct being related to attribute information of a customer acquired by the attribute acquisition unit 17, by referring to the rule table 15. Then, similarly to the first to third example embodiments, the evaluation unit 13 evaluates a conduct of the clerk by using the designated conduct. The processing of specifying a designated conduct may be performed by the recognition unit 11. In this case, the evaluation unit 13 determines whether the recognition unit 11 specifies a designated conduct, performs recognition processing using the specified designated conduct, and, when the recognition unit 11 performs the recognition processing based on the designated conduct, evaluates the conduct of the clerk by using the recognition processing result.

The configuration in the evaluation device 1 according to the fourth example embodiment other than the above is similar to that according to the first example embodiment.

Operation Example (Conduct Evaluation Method)

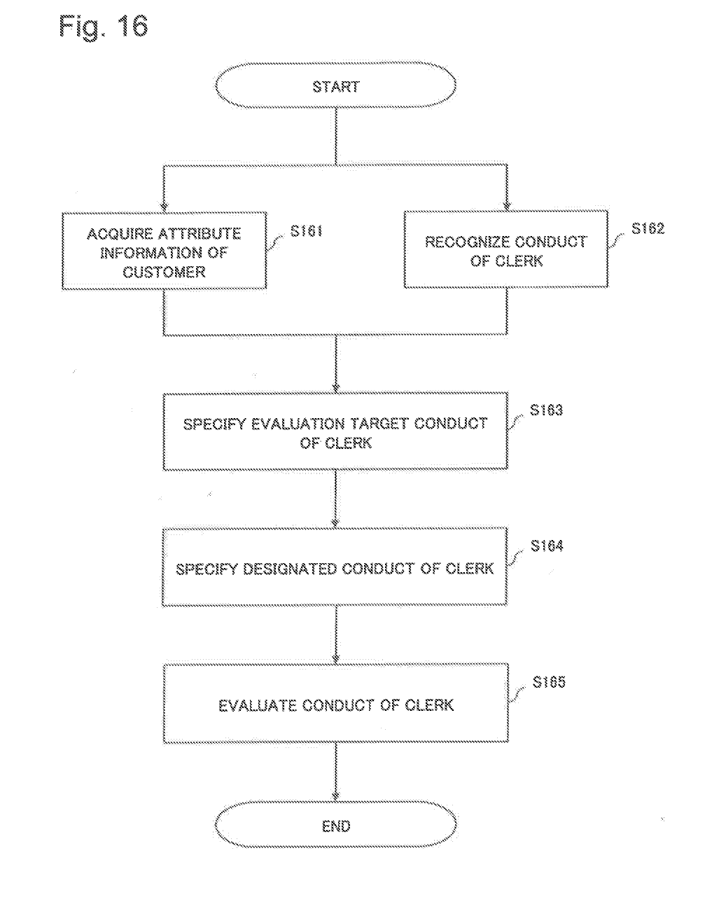

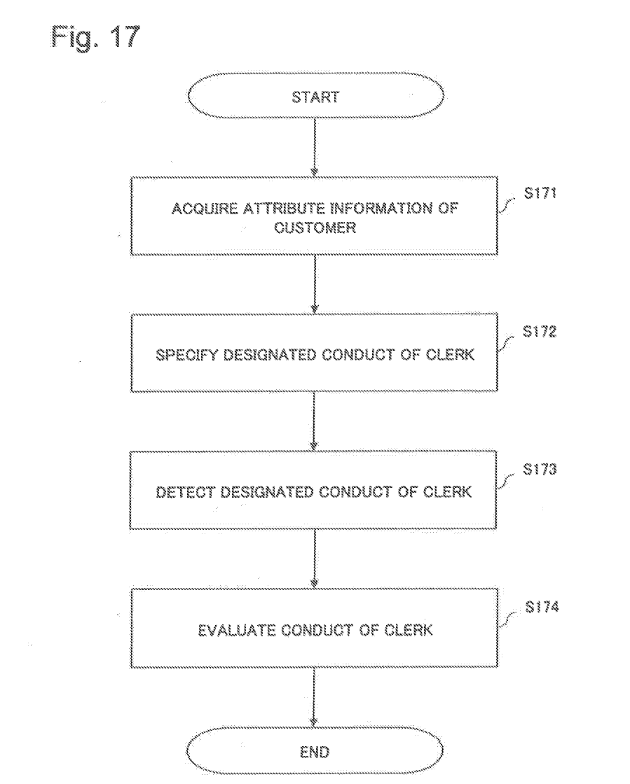

Operation examples of the evaluation device 1 according to the fourth example embodiment will be described below by using FIGS. 16 and 17. FIGS. 16 and 17 are flowcharts illustrating operation examples (control procedures) of the evaluation device 1 according to the fourth example embodiment.

In the example in FIG. 16, the attribute acquisition unit 17 in the evaluation device I acquires attribute information of a customer (S161). Further, the recognition unit II recognizes a conduct of a clerk (S162).

Then, the specification unit 14 specifies an evaluation target conduct of the clerk toward the customer with the acquired attribute information, out of the recognized conducts of the clerk (S163). The specification processing uses either or both of time information and positional information respectively associated with the acquired attribute information of the customer and the recognized conduct of the clerk.

Further, the evaluation unit 13 specifies a designated conduct of the clerk, the conduct being related to the acquired attribute information of the customer, by referring to the rule table 15 (S164). Subsequently, the evaluation unit 13 evaluates the conduct of the clerk based on the specified designated conduct and the evaluation target conduct of the clerk (S165).

In the example in FIG. 17, when the attribute acquisition unit 17 in the evaluation device 1 acquires attribute information of a customer (S171), the recognition unit 11 specifies a designated conduct of a clerk, the conduct being related to the acquired attribute information of the customer (S172).

Subsequently, the recognition unit 11 determines whether or not the specified designated conduct of the clerk is performed (whether or hot recognized) (S173). Then, the evaluation unit 13 evaluates the conduct of the clerk based on the determination result (S174).

In the example in FIG. 17, it is determined whether the clerk performs the specified designated conduct based on the attribute information, and evaluated the conduct of the clerk based on the determination result. Therefore, the processing of specifying as evaluation target conduct out of conducts of the clerk is not required.

Effect of Fourth Example Embodiment

The evaluation device 1 according to the fourth example embodiment specifies a designated conduct (recommended conduct) of a clerk, the conduct being related to acquired attribute information of a customer, and evaluates a conduct of the clerk based on a determination result of whether the clerk performs the specified conduct. In other words, the evaluation device 1 according to the fourth example embodiment evaluates a conduct of a clerk in accordance of a designated conduct of the clerk, the conduct considering attribute information of a customer, and therefore is able to properly evaluate the conduct of the clerk based on the attribute of the customer.

Specific examples of conducts (indices [designated conducts]) of a clerk that can be evaluated by the evaluation device 1 according to the second example embodiment will be described. The designated conducts are not limited to the following specific examples.

Index (Designated Conduct):

When there is a customer being an aged person (attribute information the customer being an “aged person”), a clerk says “Please have a chair.” (utterance content) “in a loud voice” (utterance characteristic).

When there is a little child (attribute information of the customer being a “little child”), a clerk performs an operation of “bring the bag close to the customer's hands” (action), saying “Bring this back home carefully.” (utterance content).

### Fifth Example Embodiment

A fifth example embodiment of the present invention will be described below. In description of the fifth example embodiment, a same reference sign is given to a component with a same designation as a component constituting the evaluation device 1 according to the first to fourth example embodiments, and redundant description of the common part is omitted.

Processing Configuration

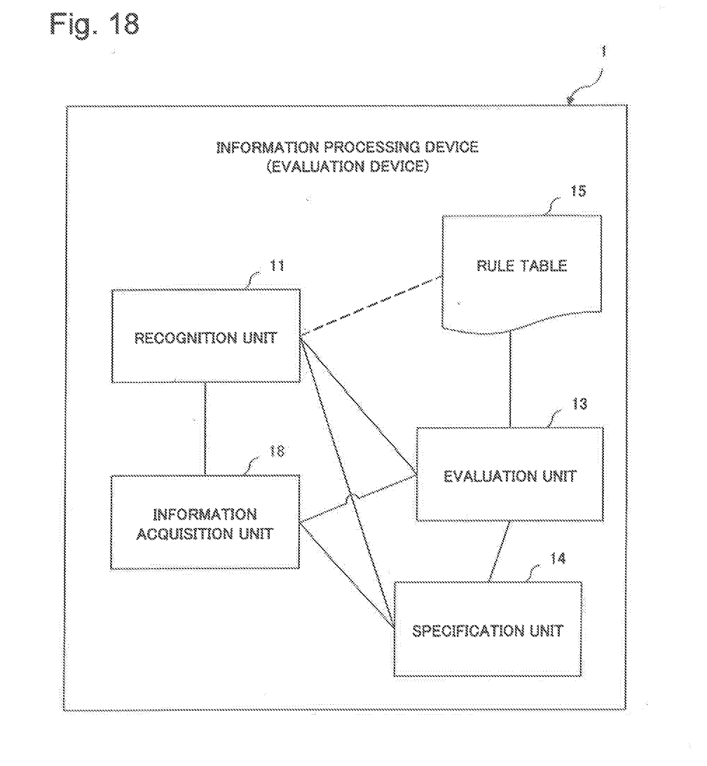

FIG. 18 is a block diagram conceptually illustrating a control configuration in the evaluation device 1 according to the fifth example embodiment. The evaluation device 1 according to the fifth example embodiment evaluates a conduct of a clerk by mainly using information about a target commodity to be purchased by a customer. Specifically, the evaluation device 1 according to the fifth example embodiment includes an information acquisition unit 18 in place of the detection unit 12 according to the first example embodiment. The information acquisition unit 18 includes a configuration similar to the configuration described in the third example embodiment and acquires commodity information of a purchase target of a customer (target commodity information).

A specification unit 14 acquires target commodity information acquired by the information acquisition unit 18 and time information thereof, and a conduct of a clerk recognized by a recognition unit 11 and time information thereof. Then, the specification unit 14 specifies an evaluation target conduct of the clerk, the conduct being related to the target commodity information, out of conducts of the clerk recognized by the recognition unit 11, based on the acquired time information. Further, the specification unit 14 may specify an evaluation target conduct out of the recognized conducts of the clerk, based on positional information of the customer purchasing the commodity and positional information of the clerk the conduct of whom is recognized by the recognition unit 11. Thus, the specification unit 14 specifies an evaluation target conduct of a clerk, the conduct being related to target commodity information, out of recognized conducts of the clerk, by using either or both of time information and positional information.

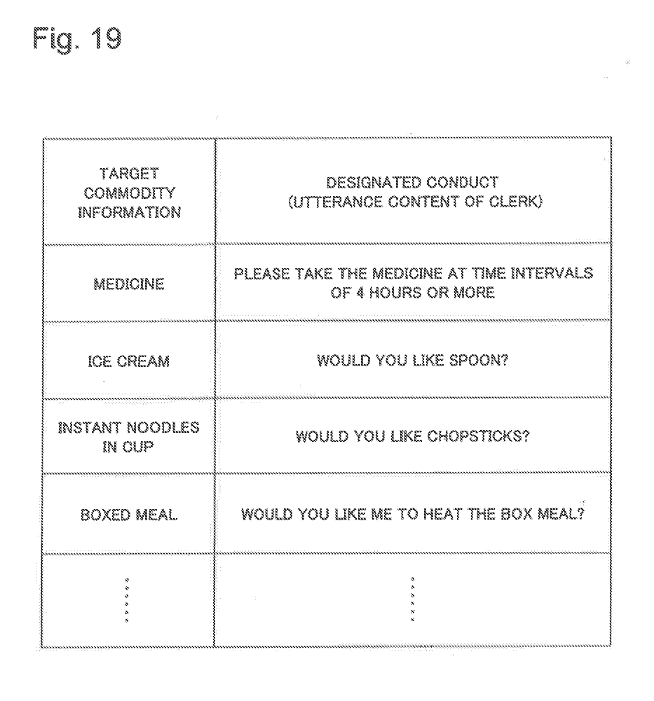

FIG. 19 is a diagram illustrating an example of a rule table 15 according to the fifth example embodiment. The rule table 15 according to the fifth example embodiment stores relation data associating target commodity information with a designated conduct of a clerk. In the example in FIG. 19, an utterance content is set as a designated conduct of a clerk. Specifically, for example, an utterance content “Would you like spoon?” is set to target commodity information “ice cream” as a designated conduct of a clerk.

The evaluation unit 13 specifies a designated conduct of a clerk, the conduct being related to target commodity information acquired by the information acquisition unit 18, by referring to the rule table 15, and evaluates a conduct of the clerk based on the specified designated conduct and the evaluation target conduct of the clerk. The processing of specifying a designated conduct may be performed by the recognition unit 11. In this case, the evaluation unit 13 determines whether the recognition unit 11 specifies a designated conduct and, when the recognition unit 11 performs recognition processing based on the designated conduct, evaluates the conduct of the clerk by using the recognition processing result by the recognition unit 11.

The configuration of the evaluation device 1 according to the fifth example embodiment other than the above is similar to that according to the first example embodiment.

Operation Example (Conduct Evaluation Method)

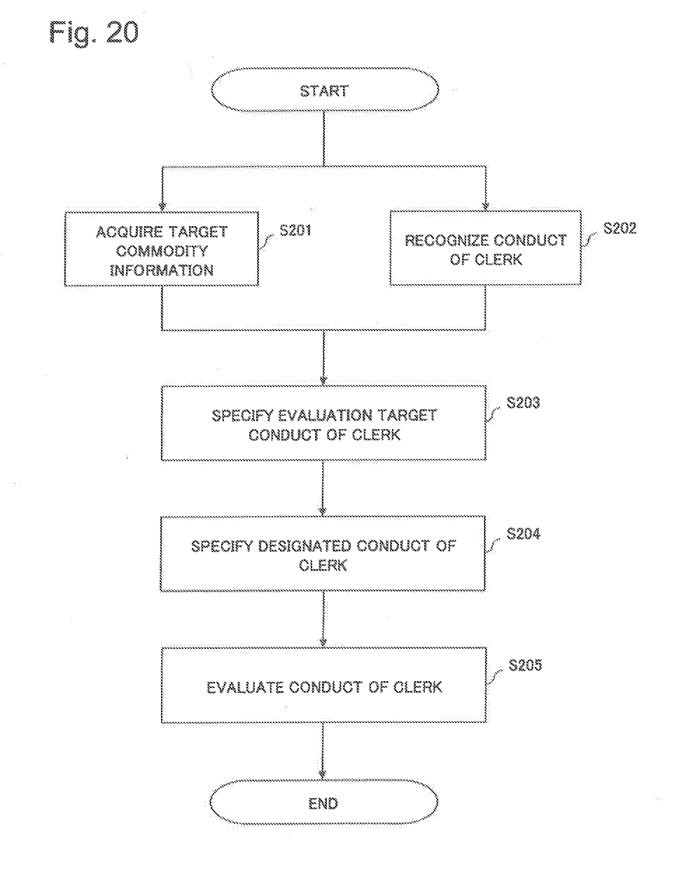

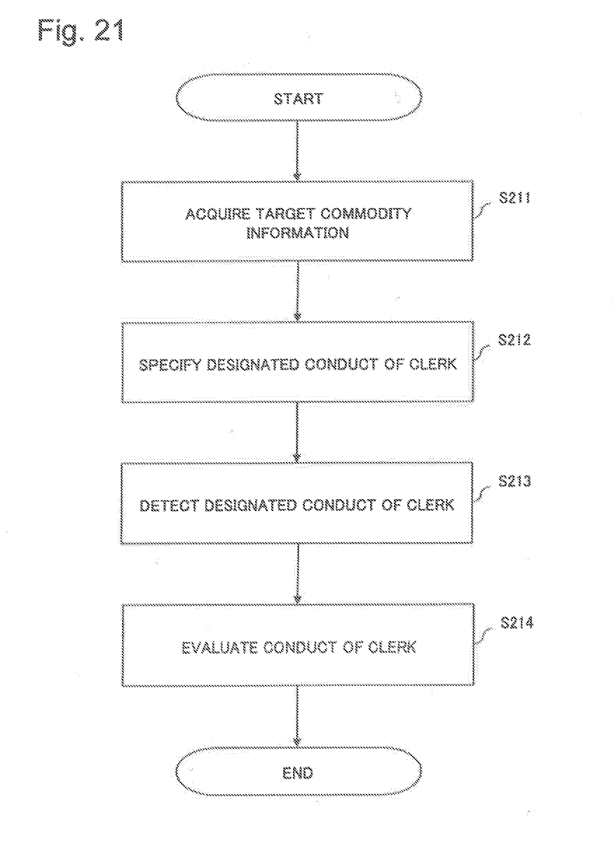

Operation examples of the evaluation device 1 according to the fifth example embodiment will be described below by using FIGS. 20 and 21. FIGS. 20 and 21 are flowcharts illustrating operation examples (processing procedures) of the evaluation device 1 according to the filth example embodiment.

In the example in FIG. 20, the information acquisition unit 18 in the evaluation device 1 acquires information about a target commodity to be purchased by a customer (S201). Further, the recognition unit 11 recognizes a conduct of a clerk (S202).

Subsequently, the specification unit 14 specifies an evaluation target conduct of the clerk out of the recognized conducts of the clerk, based on the acquired target commodity information (S203). For example, the specification processing is performed by using either or both of time information and positional information respectively associated with the acquired target commodity information and the recognized conduct of the clerk.

Then, the evaluation unit 13 specifies a designated conduct of the clerk, the conduct being related to the acquired target commodity information, by referring to the rule table 15 (S204).

In the example in FIG. 21, when the information acquisition unit 18 acquires information about a target commodity to be purchased by a customer (S211), the recognition unit 11 specifies a designated conduct of a clerk, the conduct being related to the acquired target commodity information, by referring to the rule table 15 (S212).

Then, the recognition unit 11 determines (detects) whether the clerk performs the specified designated conduct (S213). The evaluation unit 13 evaluates the conduct of the clerk based on the determination result (S214).

Thus, in the operation example in FIG. 21, the evaluation device 1 evaluates a conduct of a clerk based on a determination result of whether a specified designated conduct of the clerk is performed, and therefore an evaluation target conduct of the clerk docs not need to be specified.

Effect of Fifth Example Embodiment

The evaluation device 1 according to the fifth example embodiment acquires information about a target commodity to be purchased by a customer and recognizes a designated conduct of a clerk, the conduct being related to the acquired target commodity information. Then, the evaluation device 1 evaluates a conduct of the clerk based on the recognition result of the designated conduct (recommended conduct) of the clerk, the conduct being related to the acquired target commodity information. Accordingly, the evaluation device 1 according to the fifth example embodiment evaluates a conduct of a clerk, the conduct being related to a commodity to be purchased by a customer, and therefore is able to properly evaluate a conduct of a clerk dealing with the customer purchasing the commodity.

Specific examples of conducts (indices [designated conducts]) of a clerk that can be evaluated by the evaluation device 1 according to the fifth example embodiment will be described. The designated conducts are not limited to the following specific examples.

Index (Designated Conduct [Recommended Conduct]):

When medicine is scanned by a POS device, a clerk says “Please take the medicine at time intervals of 4 hours or more,” (utterance content).

When an ice cream is scanned by a POS device, a clerk says “Would you like spoon?” (utterance content).

When instant noodles in a cup are scanned by a POS device, a clerk says “Would you like chopsticks?” (utterance content).

When a boxed meal is scanned by a POS device, a clerk says “Would you like me to heat the box meal?” (utterance content).

### Sixth Example Embodiment

A sixth example embodiment of the present invention will be described below. In description of the sixth example embodiment, a same reference sign is given to a component with a same designation as a component constituting the evaluation device according to the first to fifth example embodiments, and redundant description of the common part is omitted.

Processing Configuration

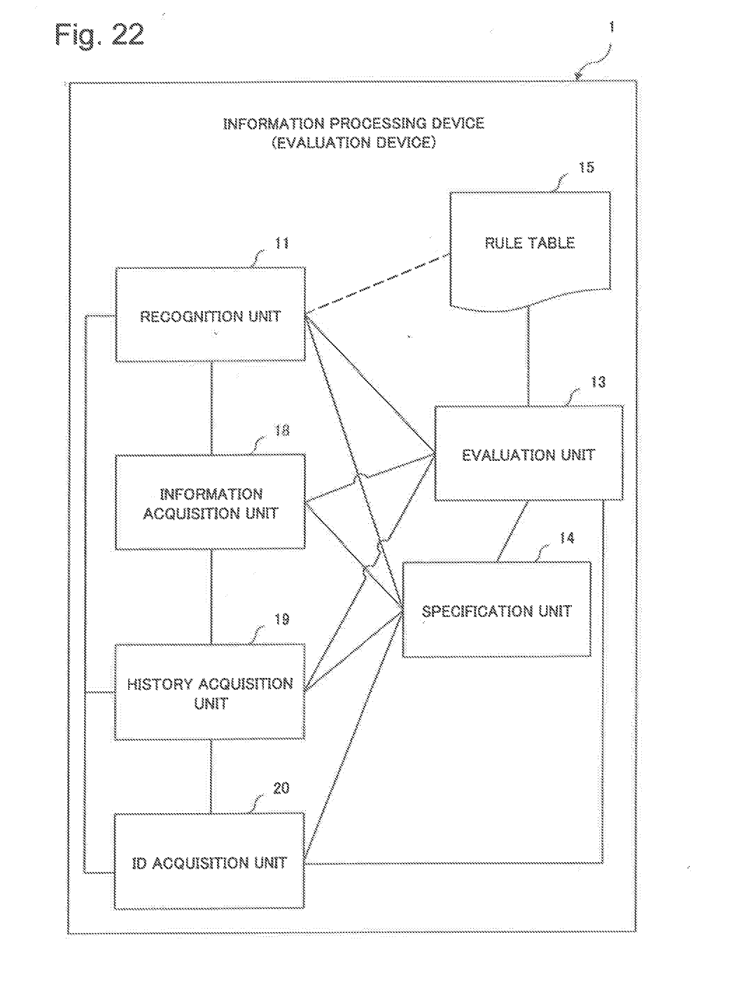

FIG. 22 is a block diagram conceptually illustrating a control configuration of an evaluation device according to the sixth example embodiment. The evaluation device 1 according to the sixth example embodiment evaluates a conduct of a clerk by using information about a target commodity to be purchased by a customer, and a history of a purchased commodity of the customer. Specifically, the evaluation device 1 according to the sixth example embodiment further includes a history acquisition unit 19 and an ID acquisition unit 20, in addition to the configuration according to the fifth example embodiment. For example, the history acquisition unit 19 and the ID acquisition unit 20 are provided by a CPU 2.

The ID acquisition unit 20 acquires a customer ID individually distinguishing a customer. The customer ID may also be referred to as a personal ID. For example, a customer ID is acquired by a FOS device from a point card or an electronic money card presented by a customer. In this case, the ID acquisition unit 20 acquires the customer ID from the POS device. Alternatively, the ID acquisition unit 20 may acquire a customer ID from a face authentication system (unillustrated). In this case, the face authentication system distinguishes a customer by processing a captured image of the customer by using a face recognition technology, and specifies au ID of the distinguished customer. The ID acquisition unit 20 may have a function of the face authentication system.

The history acquisition unit 19 is connectable to a history database (DB) (unillustrated). The history database stores history information of a purchased commodity for each customer. The history acquisition unit 19 extracts a history of a purchased commodity of a customer from the history database by using a customer ID acquired by the ID acquisition unit 20. Additionally, the history acquisition unit 19 may extract the following information from the history database by using the extracted history information of the purchased commodity. The information to be extracted includes information about a same type of commodity as a commodity specified based on target commodity information acquired by an information acquisition unit 18, a purchase count of the same type of commodity, and ranking information about a past purchase count. For example, a commodity type may be defined by classification set in a commodity classification table by the Ministry of Economy, Trade, and Industry of Japan. A history of a purchased commodity and information obtained from the history are also collectively referred to as purchase history information. Further, the history database may be provided by the evaluation device 1 or provided by an external device.

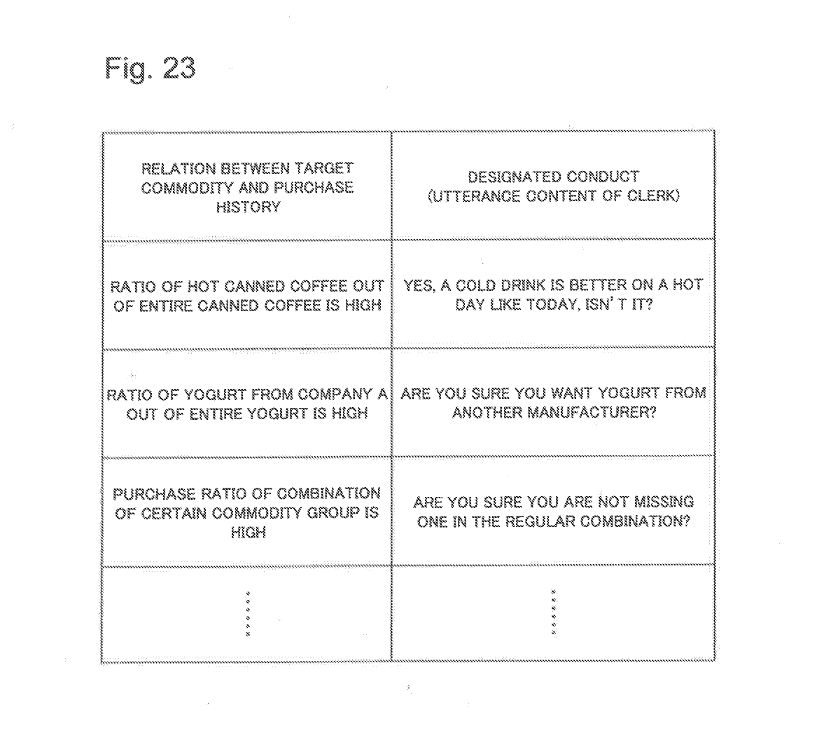

FIG. 23 is a diagram illustrating an example of a rule table 15 according to the sixth example embodiment. The rule table 15 according to the sixth example embodiment stores relation data associating a relation between a target commodity and a purchase history with a designated conduct of a clerk. In the example in FIG. 23, an utterance content is set as a designated conduct of a clerk.

An evaluation unit 13 specifies a designated conduct of a clerk, the conduct being related to target commodity information acquired by the information acquisition unit 18 and commodity history information acquired by the history acquisition unit 19, by referring to the rule table 15. For example, the evaluation unit 13 compares at least one piece of target commodity information acquired by the information acquisition unit 18 with purchase history information acquired by the history acquisition unit 19. By the comparison, the evaluation unit 13 determines whether the target commodity information is acquired under a condition not satisfying a relation set in the rule table 15 between the target commodity and the purchase history. When determining that the target commodity information is thus acquired, the evaluation unit 13 specifies a designated conduct of a clerk set in the rule table 15. Then, the evaluation unit 13 evaluates the conduct of the clerk based on the specified designated conduct and the evaluation target conduct of the clerk. The processing of specifying a designated conduct may be performed by the recognition unit 11. In this case, the evaluation unit 13 determines whether the recognition unit 11 specifies a designated conduct and performs recognition processing based on the specified designated conduct. Then, when the recognition unit 11 performs the recognition processing using the designated conduct, the evaluation unit 13 evaluates the conduct of the clerk by using the recognition result by the recognition unit 11.

The configuration in the evaluation device 1 according to the sixth example embodiment other than the above is similar to that in the evaluation device 1 according to the fifth example embodiment.

Operation Example (Conduct Evaluation Method)

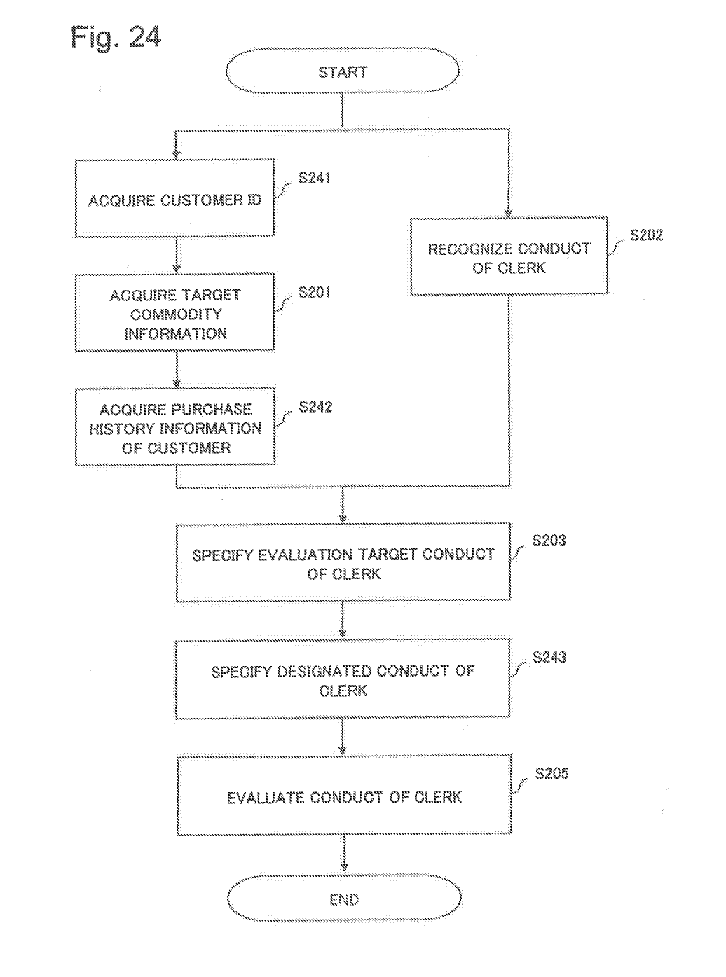

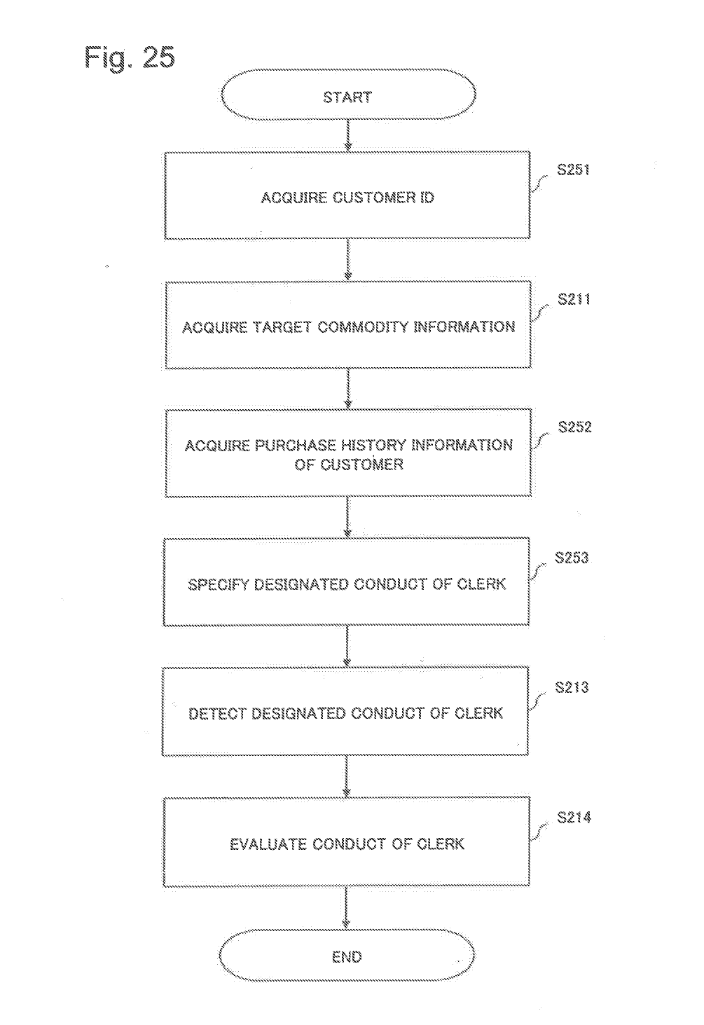

Operation examples of the evaluation device 1 according to the sixth example embodiment will be described below by using FIGS. 24 and 25. FIGS. 24 and 25 are flowcharts illustrating operation examples (processing procedures) of the evaluation device 1 according to the sixth example embodiment. In FIG. 24, a same reference sign in FIG. 20 is given to same processing as that in the flowchart in FIG. 20. Further, in FIG. 25, a same reference sign in FIG. 21 is given to same processing as that in the flowchart in FIG. 21.

In the example in FIG. 24, the ID acquisition unit 20 in the evaluation device 1 acquires a customer ID (S241). Then, when the information acquisition unit 18 acquires information about a target commodity to be purchased by the customer (S201 ), the history acquisition unit 19 acquires purchase history information of the customer from the history database (unillustrated) by using the acquired customer ID (S242). Further, the recognition unit 11 recognizes a conduct of a clerk (S202).

Subsequently, a specification unit 14 specifies an evaluation target conduct out of the recognized conducts of the clerk (S203). Then, by referring to the rule table 15, the evaluation unit 13 specifies a designated conduct of the clerk, the conduct being related to the acquired target commodity information and the purchase history information (S243). The evaluation unit 13 evaluates the conduct of the clerk based on the specified designated conduct of the clerk and the evaluation target conduct (S205).

In the example in FIG. 25, the ID acquisition unit 20 acquires a customer ID (S251). Then, when the information acquisition unit 18 acquires information about a target commodity to be purchased by the customer (S211), the history acquisition unit 19 acquires purchase history information of the customer from the history database (unillustrated) by using the acquired customer ID (S252).

Additionally, the recognition unit 11 specifies a designated conduct of a clerk, the conduct being related to the acquired target commodity information and the purchase history information, by referring to the rule table 15 (S253). Then, the recognition unit 11 determines (detects) whether the clerk performs the designated conduct (S213). Consequently, the evaluation unit 13 evaluates the conduct of the clerk by using the determination result (S214).

Effect of Sixth Example Embodiment

The evaluation device 1 according to the sixth example embodiment acquires information about a target commodity to be purchased by a customer and further acquires purchase history information of the customer. Then, the evaluation device 1 according to the sixth example embodiment specifies a designated conduct (recommended conduct) of a clerk, the conduct being related to the acquired target commodity information and the purchase history information, and evaluates a conduct of the clerk by using the designated conduct. Thus, the evaluation device 1 according to the sixth example embodiment performs an evaluation considering histories of a commodity to be purchased by a customer and a purchased commodity, and therefore is able to properly evaluate a conduct of a clerk dealing with a customer purchasing a commodity.

Specific examples of conducts (indices [designated conducts]) of a clerk that can be evaluated by the evaluation device 1 according to the sixth example embodiment will be described. The designated conducts are not limited to the following specific examples.

Index (Designated Conduct):

When a customer mostly purchasing hot coffee in the past suddenly purchases iced coffee, a clerk says “Yes, a cold drink is better on a hot day like today, isn't it?”

When a customer normally purchasing yogurt from Company A purchases yogurt from another manufacturer, a clerk says “Are you sure you want yogurt from another manufacturer?”

When a customer always purchasing a same combination of three commodities purchases a combination of only two of the three commodities, a clerk says “Are you sure you are not missing one in the regular combination?”

### First Modified Example

Without being limited to the respective first to sixth example embodiments, the present invention may take various example embodiments. For example, the evaluation device I according to the respective first to sixth example embodiments holds the rule table 15. Instead, the evaluation device 1 may not hold the rule table 15. In this case, the rule table 15 is held by another device accessible to the evaluation device 1, and the evaluation device 1 may be configured to read the rule table 15 from the device. Further, the rule table 15 may be incorporated into a program as processing branched by each condition instead of in a form of a table (tabular data).

### Second Modified Example

In addition to the configuration according to the respective first to sixth example embodiments, a timing of a conduct of a clerk may be added to an evaluation target. In this case, the evaluation unit 13 acquires a time threshold related to the trigger state of a customer detected by the detection unit 12, and evaluates a conduct of a clerk by using the acquired time threshold and a detecting time of the trigger state of the customer by the detection unit 12. The time threshold may be stored in the rule table 15, and the evaluation unit 13 may acquire the time threshold from the rule table 15,

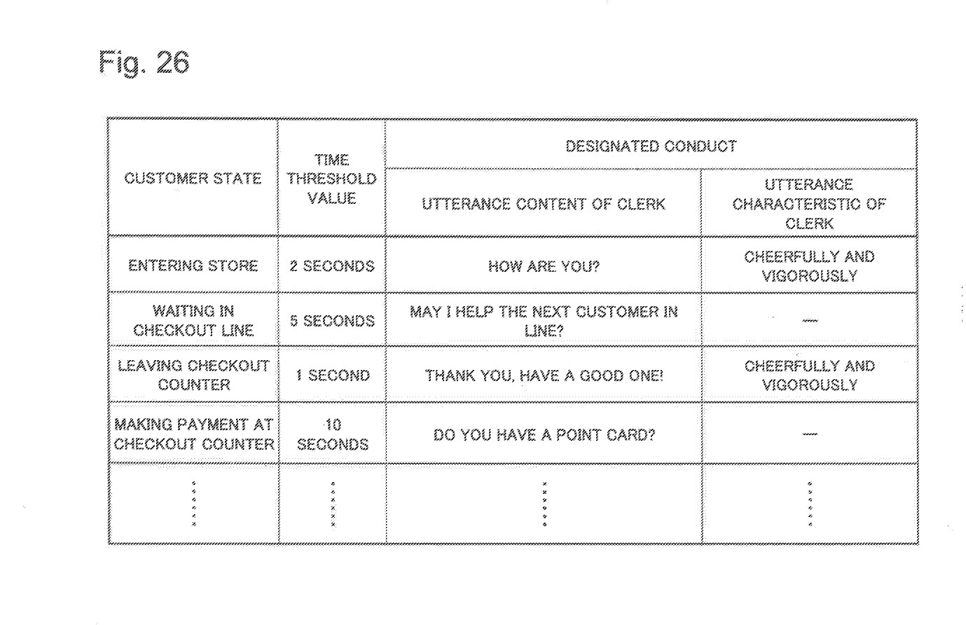

FIG. 26 is a diagram illustrating a modified example of the rule table 15. In the modified example illustrated in FIG. 26, the rule table 15 stores relation data further associating time threshold information with data associating a designated conduct of a clerk with a customer state. For example, in the example in FIG. 26, a time threshold “2 seconds” is set to a customer state “entering the store.” Further, a time threshold “5 seconds” is set to a customer state “waiting in a checkout line.”

When the rule table 15 including a time threshold is used, the evaluation unit 13 specifies a designated conduct of a clerk based on a detecting time of the trigger state of a customer, an elapsed time from the detecting time, and a time threshold (e.g. 5 seconds). Then, the evaluation unit 13 evaluates a conduct of the clerk based on the specified designated conduct. Further, the evaluation unit 13 may determine (predict) whether the clerk performs the designated conduct by a time tracing back a time corresponding to the time threshold from the detecting time of the trigger state of the customer. Consequently, the conduct of the clerk can be evaluated at a timing of the customer entering into the trigger state.

The aforementioned time threshold may be specified based on attribute information of a customer acquired by the attribute acquisition unit 17 or target commodity information acquired by the information acquisition unit 18. Consequently, the evaluation device 1 is able to evaluate a conduct of a clerk at a timing related to an age group, a gender, and a target commodity. Further, the evaluation unit 13 may evaluate a conduct of a clerk by using time information associated with attribute information of a customer or target commodity information, and a time threshold thereof, without using the trigger state of the customer. For example, the evaluation unit 13 determines whether a clerk performs a designated conduct by a time when a time threshold elapses from a time indicated by time information of attribute information or target commodity information.

### Third Modified Example

Each customer may generally and habitually determine a service to be enjoyed and a service not to be enjoyed, out of various services provided by a store. For example, one customer always requests milk and sugar at a coffee shop while another customer requests neither. Further, one customer always presents a point card while another customer does not. Since such a habit for each customer changes a conduct required for a clerk, a conduct of a clerk may be evaluated by further using habit information of a customer, according to the respective aforementioned example embodiments.

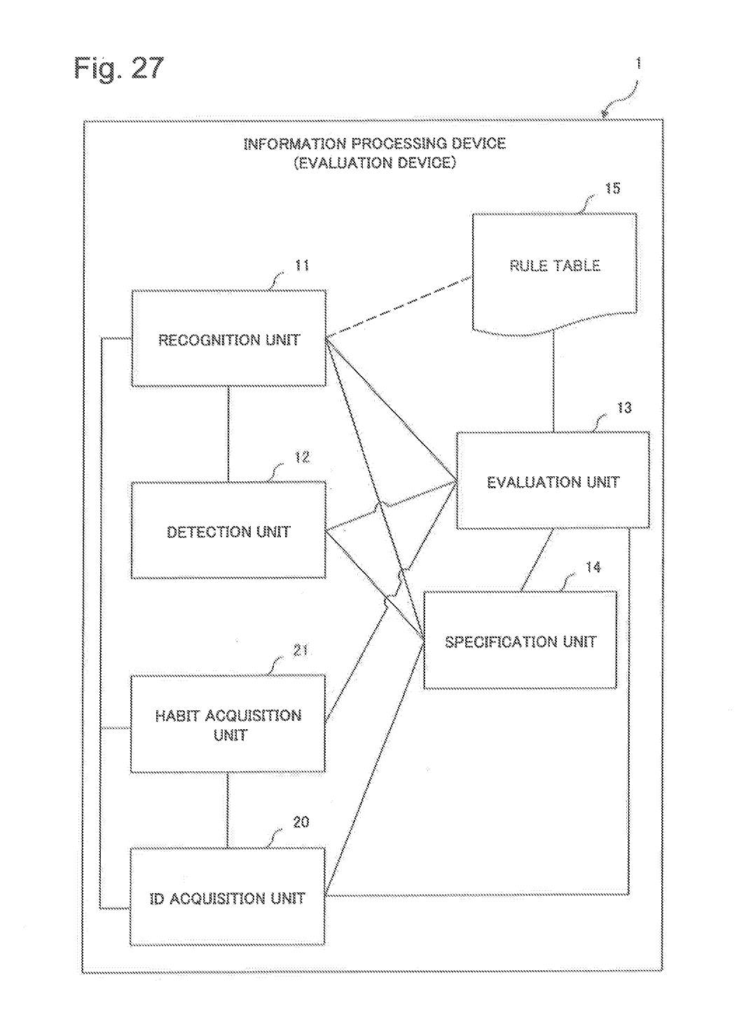

FIG. 27 is a block diagram conceptually illustrating a control configuration of an evaluation device 1 according to a third modified example. In addition to the configuration according to the first example embodiment, the evaluation device 1 according to the third modified example includes a configuration reflecting the description above. Note that the configuration specific to the third modified example is also applicable to the respective second to sixth example embodiments.

In addition to the configuration according to the first example embodiment, the evaluation device 1 according to the third modified example further includes an ID acquisition unit 20 and a habit acquisition unit 21. For example, the ID acquisition unit 20 and the habit acquisition unit 21 are provided by a CPU 2.

Similarly to the ID acquisition unit 20 according to the sixth example embodiment, the ID acquisition unit 20 is configured to acquire a customer ID of a customer the trigger state of whom is detected by a detection unit 12.

The habit acquisition unit 21 acquires habit information of a customer based on a customer ID acquired by the ID acquisition unit 20. In other words, the habit acquisition unit 21 according to the third modified example acquires habit information of a customer the trigger state of whom is detected. Habit information for each customer is stored in a habit database (DB) (unillustrated) in a state associated with a customer ID, and the habit acquisition unit 21 extracts habit information related to a customer ID from the habit database.

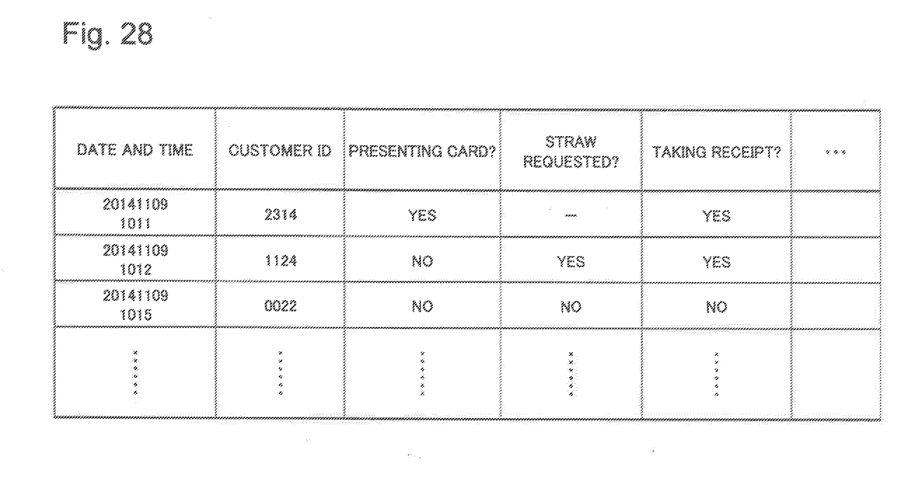

FIG. 28 is a diagram illustrating an example of the habit database. The habit database stores a date and time, a customer ID, and implementation status for each service, in a mutually associated manner. FIG. 28 exemplifies “presenting a point card,” “a straw requested or not,” and “taking a receipt” as implementation status for each service. Note that a service type set as implementation status in the habit database is not limited. The evaluation device 1 may include the habit database, or the habit database may be held in another device, and information in the habit database may be read from the device. For example, by input to a POS device by a clerk, information is accumulated into a habit database included in the POS device.

For example, by extracting information matching a customer ID acquired by the ID acquisition unit 20 from the habit database and statistically processing the extracted information, the habit acquisition unit 21 acquires habit information of the customer. The acquired habit information indicates statistical implementation status for each service. In the example in FIG. 28, acquired habit information indicates, for example, contents such as “generally presenting a point card” and “seldom taking a receipt.”

An evaluation unit 13 specifies a designated conduct of a clerk (evaluated person), the conduct being related to the trigger state of a customer detected by the detection unit 12, based on habit information acquired by the habit acquisition unit 21, and determines whether to evaluate the clerk by using the specified designated conduct. For example, when acquired habit information indicates a certain service is seldom enjoyed, the evaluation unit 13 does not perform an evaluation of a clerk based on a designated conduct related to the service indicated by the habit information. The reason is that a conduct of a clerk, the conduct being related to a service habitually not requested by a customer, does not influence a customer-serving image of the clerk with the customer. In addition, from a viewpoint of the customer, the clerk refrains from the conduct based on a habit of the customer, and therefore the customer-serving image of the clerk may improve. Accordingly, when a designated conduct is not performed, conforming to a habit information of a customer, the evaluation unit 13 may evaluate the conduct of the clerk in a positive direction.

The evaluation device 1 according to the third modified example evaluates a conduct of a clerk toward a customer in consideration of a habit for each customer, and therefore is able to properly evaluate the conduct of the clerk toward the customer.

### Fourth Modified Example

An evaluation result by the evaluation unit 13 may be output as follows. However, an output form of an evaluation result by the evaluation unit 13 is not limited to the following example.

For example, the evaluation device 1 accumulates, for a certain period (e.g. one day), data associating an evaluation result of the evaluation unit 13 with a detecting result of the trigger state of a customer and a recognition result of a conduct of a clerk, the detecting result and the recognition result being bases of the evaluation result, and time information of each result. The evaluation device 1 outputs a list of accumulated data. The output is performed by file output in text data, display, printout, and the like. The output allows an evaluation result of when and in what situation a conduct of a clerk is proper or not to be readily graspable.

Further, the evaluation device 1 may totalize evaluation results based on a situation (the trigger state and an attribute of a customer, and a commodity to be purchased by the customer) by using accumulated data. For example, the evaluation device 1 may calculate a ratio of a clerk performing a proper conduct for each trigger state of a customer, based on a number of times each trigger state of a customer is detected and a number of times a conduct of the clerk is determined to be proper out of the entire detecting count. The evaluation device 1 may calculate such a ratio for each store, for each clerk, for each time period, and the like. By using a calculation result, the evaluation device 1 may output an evaluation for each situation such as “utterance at customer entrance into the store rated high.” By totalizing such an overall rating for each store and accumulating the totalization result for a long period, the evaluation device 1 is able to provide information about an evaluation of a conduct of a clerk at each store. For example, at a company operating a store at a remote location, the evaluation device 1 has a function of displaying a store name, a ratio of utterance of “How are you?” in a cheerful voice at customer entrance into the store, and an utterance rating based on the ratio. Consequently, for example, the management of the company is able to grasp an atmosphere in the store even at a remote location, by the display of the evaluation device 1. Further, in a case of poor utterance rating, the management may guide the store to utter cheerfully. Additionally, for example, by implementing a function of updating and displaying a graph indicating an evaluation result as time progresses, the evaluation device 1 may provide the management with change in a conduct of a clerk before and after customer service guidance.

Further, as described in the second modified example, when a timing of a conduct of a clerk is added to an evaluation target, the evaluation device 1 may immediately output an evaluation result by the evaluation unit 13. For example, the evaluation device 1 displays the evaluation result or an alert related to the evaluation result on a display unit visually recognizable to a clerk or a store manager. Consequently, when a clerk does not say what needs to be said within a predetermined time, a store manager is able to provide guidance immediately based on the output.

### Fifth Modified Example

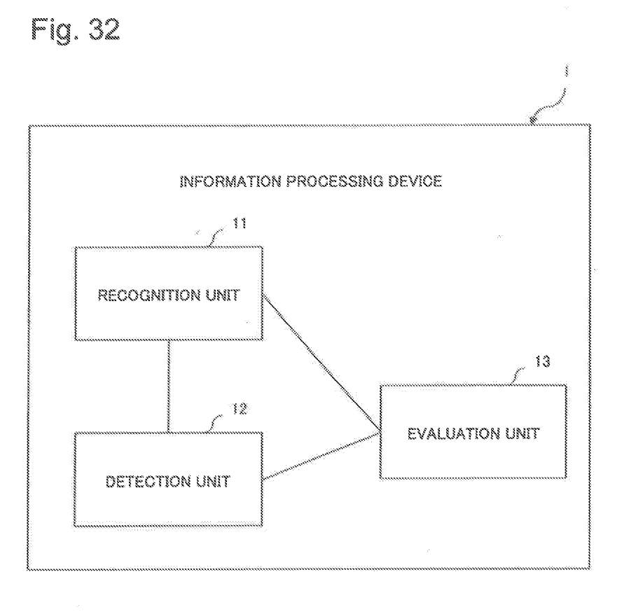

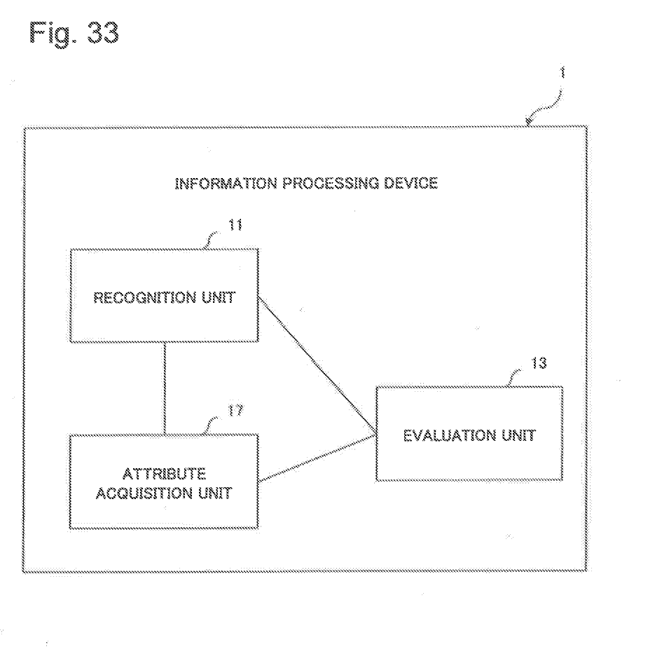

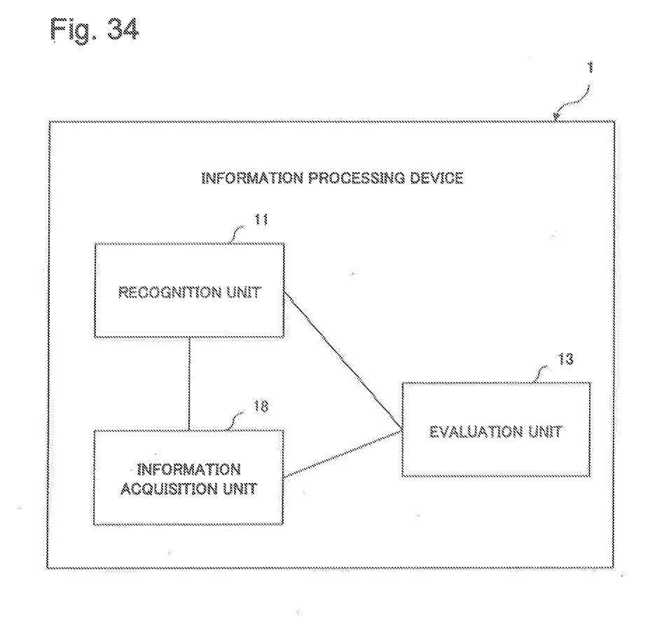

While the information processing device 1 according to the respective first to sixth example embodiments includes the specification unit 14, the specification unit 14 may be omitted as illustrated in FIGS. 32 to 34. In this case, every conduct of a clerk (evaluated person) recognized by the recognition unit 11 becomes an evaluation target.

### Supplement

While the flowcharts described in the respective first to sixth example embodiments describe a plurality of steps (processing) in a sequential order, an execution order of the steps is not limited to the order of description. The order of steps indicated in the respective example embodiments may be changed without interfering the content.

Further, the respective aforementioned example embodiments and modified examples may be combined as exemplified in the following examples, without contradicting one another. However, the combinations are not limited to the following examples.

### Combination Example 1

The evaluation device 1 is able to evaluate a conduct of a clerk by using the trigger state of a customer and information about a target commodity to be purchased by the customer, without using attribute information of the customer. In this case, the attribute acquisition unit 17 is omitted from the control configuration of the evaluation device 1 in FIG. 10.

### Combination Example 2

The evaluation device 1 is also able to evaluate a conduct of a clerk by using attribute information of a customer and information about a target commodity to be purchased by the customer. In this case, the detection unit 12 is omitted from the control configuration of the evaluation device 1 in FIG. 10.

### Combination Example 3

The evaluation device 1 is also able to evaluate a conduct of a clerk by using attribute information of a customer, information about a target commodity to be purchased by the customer, and a history of a purchased commodity of the customer. In this case, the attribute acquisition unit 17 is added to the control configuration of the evaluation device 1 in FIG. 22.

### Combination Example 4

The evaluation device 1 is also able to evaluate a conduct of a clerk by using the trigger state of a customer, information about a target commodity to be purchased by the customer, and a history of a purchased commodity of the customer. In this case, the detection unit 12 is added to the control configuration example of the evaluation device 1 in FIG. 22.

### Combination Example 5

The evaluation device 1 is also able to evaluate a conduct of a clerk by using the trigger state of a customer, attribute information of the customer, information about a target commodity to be purchased by the customer, and a history of a purchased commodity of the customer. In this case, the history acquisition unit 19 is added to the control configuration example of the evaluation device 1 in FIG. 10.

### Combination Example 6

The evaluation device 1 is also able to evaluate a conduct of a clerk by using information about a target commodity to be purchased by a customer and habit information of the customer.

As described above, the evaluation device 1 detects the trigger state of a customer based on some sort of basic data, and recognizes a conduct of a clerk (the recognition unit 11 and the detection unit 12). The respective aforementioned example embodiments do not limit the basic data. For example, the basic data may include voice data obtained from a microphone, a captured image (a dynamic image or a static image) obtained from a camera, information obtained from a POS device, and sensor information obtained from a sensor. The microphone, the camera, the sensor, and the like may be installed at a position and in a direction suited to a purpose. An existing camera installed in a store may be used, or a dedicated camera may be installed. The evaluation device 1 is connectable to a microphone, a camera, a sensor, and the like through the input-output I/F 4 or the communication unit 5.

A specific example will be gives below to describe the above more in detail. The specific example described below is a specific example of as embodiment applying the configuration according to the second modified example to the first example embodiment. The present invention is not limited to the following specific example.

### Specific Example

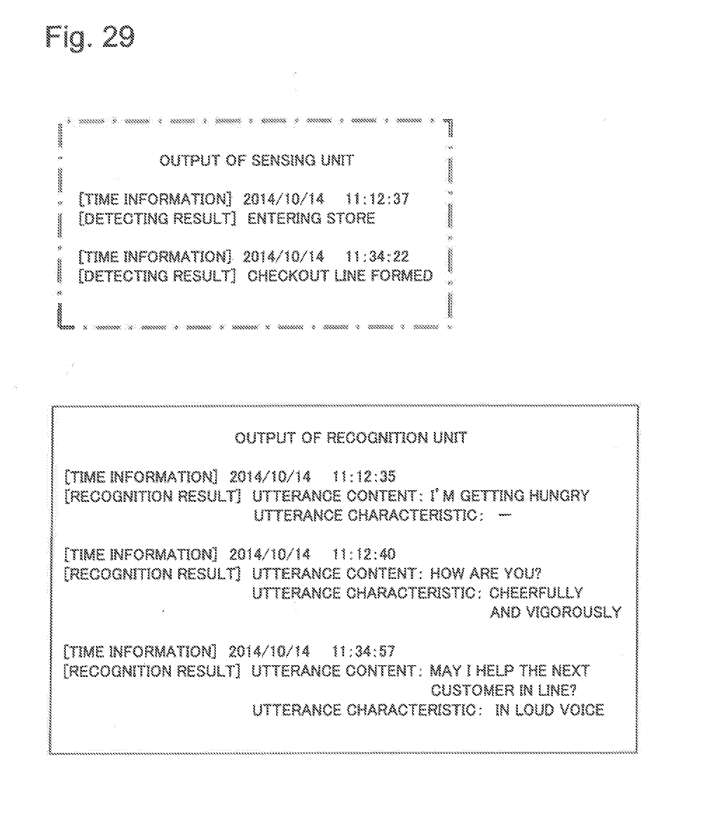

In this specific example, an evaluation device 1 acquires an image frame from a surveillance camera in a store and acquires voice data from a microphone attached to a clerk. The evaluation device 1 attempts to detect the trigger state of a customer from one or more Image frames (a detection unit 12). Meanwhile, the evaluation device 1 successively recognizes an utterance content and an utterance characteristic (emotion information) of the clerk from acquired voice data by using a speech recognition technology, a natural language processing technology, an emotion recognition technology, and the like (a recognition unit 11). It is assumed that output information as illustrated in an example in FIG. 29 is consequently obtained.

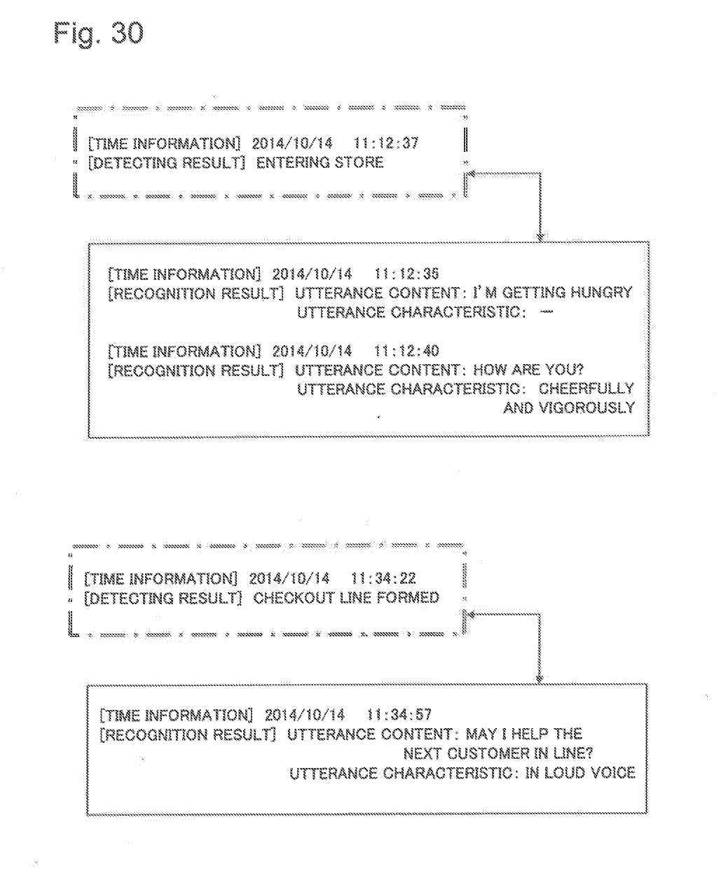

FIG. 29 is a diagram illustrating an example of output information of the recognition unit 11 and the detection unit 12. FIG. 30 is a diagram illustrating an example of information specified by a specification unit 14. The detection unit 12 detects customer states of “entering the store” and “waiting in a checkout line,” and outputs detecting times thereof along with information indicating the detected states. The recognition unit 11 recognizes three speeches of the clerk, and outputs recognition times of the recognized speeches along with information indicating the recognized speeches. An utterance characteristic “-” illustrated in FIG. 30 indicates that utterance characteristics “cheerfully and vigorously” and “in a loud voice” being designated conducts are not recognized.

Based on a temporal relation between time information of a detecting result and time information of a recognition result, the specification unit 14 specifies a speech of the clerk being an evaluation target related to the trigger state of a customer detected by the detection unit 12, as illustrated in FIG. 30. Specifically, with respect to the customer state “entering the store,” two speeches are specified in a recognition time within one minute before and after a detecting time of the state. Further, with respect to the customer state “waiting in a checkout line,” one speech is specified in a recognition time within one minute from a detecting time of the state.

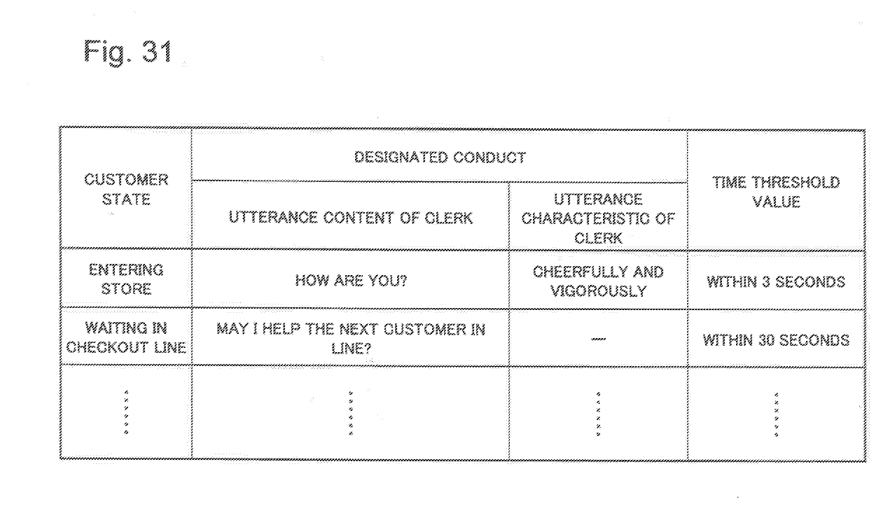

FIG. 31 is a diagram illustrating a rule table 15 in the specific example. In the specific example, the rule table 15 stores a customer state, an utterance content and an utterance characteristic being designated conducts of a clerk, and a time threshold, in a mutually associated manner. An evaluation unit 13 refers to the rule table 15 to specify designated conducts (an utterance content and an utterance characteristic) of the clerk, the conducts being related to each trigger state of the customer, and a time threshold. For each trigger state of the customer, the evaluation unit 13 checks a speech of the clerk specified by the specification unit 14 against designated conducts (an utterance content and an utterance characteristic), respectively. With respect to the customer state “entering the store” in FIG. 30, a speech matching the utterance content “How are you?” and the utterance characteristic “cheerfully and vigorously” being designated conducts exist in a specified speech of the clerk. Similarly, with respect to the customer state “waiting in a checkout line” in FIG. 30, a speech matching the utterance content “May I help the next customer in line?” and the designated utterance characteristic “in a loud voice” being designated conducts exist in a specified speech of the clerk. The evaluation unit 13 determines timings of the respective designated conducts based on the specified time thresholds (3 seconds and 30 seconds). The utterance content “How are you?” is recognized within 3 seconds (time threshold) from a detecting time (11:12:37) of the customer state “entering the store,” and therefore the evaluation unit 13 determines an evaluation result of the conduct of the clerk with respect to the customer state “entering the store” as “good.” However, the utterance content “May I help the next customer in line?” is not recognized within 30 seconds (time threshold) from a detecting time (11:34:22) of the customer state “waiting in a checkout line.” Accordingly, the evaluation unit 13 determines an evaluation result of the conduct of the clerk with respect to the customer state “waiting in a checkout line” as “poor.”

The aforementioned example embodiments may also be described in part or in whole as the following Supplementary Notes but are not limited thereto.

### Supplementary Note 1

An information processing device including:

a recognition unit that recognizes a conduct of an evaluated person:

a detection unit that detects a trigger state of another person; and

an evaluation unit that evaluates a conduct of the evaluated person based on a recognition result of a designated conduct of the evaluated person by the recognition unit, the designated conduct being related to the trigger state of another person detected by the detection unit.

### Supplementary Note 2

The information processing device according to Supplementary Note 1, wherein,

from correspondence information including a plurality of correspondence relations between a designated conduct expected of the evaluated person and a state of another person, the evaluation unit specifies the designated conduct of the evaluated person, the designated conduct being related to the trigger state of another person detected by the detection unit.

### Supplementary Note 3

The information processing device according to Supplementary Note 1 or 2, wherein

the evaluation unit
acquires a time threshold related to the trigger state of another person detected by the detection unit, and
evaluates a conduct of the evaluated person by using a recognition result of a designated conduct of the evaluated person by the recognition unit or time information of a designated conduct of the evaluated person recognized by the recognition unit, the acquired time threshold, and a detecting time of the trigger state of another person by the detection unit.

### Supplementary Note 4

The information processing device according to Supplementary Note 3, wherein,

from correspondence information further including, in addition to a plurality of correspondence relations between a designated conduct expected of the evaluated person and a state of another person, a plurality of time thresholds associated with respective correspondence relations, the evaluation unit acquires the time threshold related to the trigger state of another person detected by the detection unit.

### Supplementary Note 5

The information processing device according to any one of Supplementary Notes 1 to 4, further including

an attribute acquisition unit that acquires attribute information of the another person, wherein

the evaluation unit specifies the designated conduct of the evaluated person by further using attribute information acquired by the attribute acquisition unit with respect to another person the trigger state of whom is detected by the detection unit.

### Supplementary Note 6

The information processing device according to Supplementary Note 5, wherein,

from correspondence information including a plurality of correspondence relations between a designated conduct expected of the evaluated person, a state of another person, and attribute information of another person, the evaluation unit specifies the designated conduct of the evaluated person, the designated conduct being related to the trigger state of another person detected by the detection unit and the attribute information of another person acquired by the attribute acquisition unit.

### Supplementary Note 7

The information processing device according to any one of Supplementary Notes 1 to 6, further including

an information acquisition unit that acquires information about a target commodity to be purchased by the another person, wherein

the evaluation unit specifies the designated conduct of the evaluated person by further using information about a target commodity acquired by the information acquisition unit with respect to another person the trigger state of whom is detected by the detection unit.

### Supplementary Note 8

The information processing device according to Supplementary Note 7, further including:

an ID acquisition unit that acquires a personal ID individually distinguishing the another person, and

a history acquisition unit that acquires purchase history information of the another person based on the acquired personal ID, wherein

the evaluation unit specifies the designated conduct of the evaluated person by further using information about a target commodity acquired by the information acquisition unit and purchase history information acquired by the history acquisition unit, with respect to another person the trigger state of whom is detected by the detection unit.

### Supplementary Note 9

The information processing device according to any one of Supplementary Notes 1 to 8, further including

a specification unit that specifies, based on time information of the trigger state of another person detected by the detection unit and time information of a conduct of the evaluated person recognized by the recognition unit, a conduct of the evaluated person evaluated with respect to the trigger state of another person detected from one or more recognized conducts of the evaluated person, wherein

the evaluation unit evaluates a conduct of the evaluated person by checking the conduct of the evaluated person specified by the specification unit against the designated conduct of the evaluated person, the designated conduct being related to the trigger state of the another person.

### Supplementary Note 10

The information processing device according to Supplementary Note 9, wherein

the specification unit specifies a conduct of the evaluated person to be evaluated, by further using positional information of another person the trigger state of whom is detected by the detection unit and positional information of the evaluated person a conduct of whom is recognized by the recognition unit.

### Supplementary Note 11

An information processing device including:

a recognition unit that recognizes a conduct of an evaluated person;

an attribute acquisition unit that acquires attribute information of another person; and

an evaluation unit that evaluates a conduct of the evaluated person based on a recognition result of a designated conduct of the evaluated person by the recognition unit, the designated conduct being related to attribute information of another person acquired by the attribute acquisition unit.

### Supplementary Note 12

The information processing device according to Supplementary Note 11, wherein,

from correspondence information including a plurality of correspondence relations between a designated conduct expected of the evaluated person and attribute information of another person, the evaluation unit specifies the designated conduct of the evaluated person, the designated conduct being related to the attribute information of another person acquired by the attribute acquisition unit.

### Supplementary Note 13

The information processing device according to Supplementary Note 11 or 12, wherein

the evaluation unit acquires a time threshold related to the attribute information of another person acquired by the attribute acquisition unit, and evaluates a conduct of the evaluated person by further using the acquired time threshold and an acquisition time of the attribute information of another person by the attribute acquisition unit.

### Supplementary Note 14

The information processing device according to Supplementary Note 13, wherein,

from correspondence information further including, in addition to a plurality of correspondence relations between a designated conduct expected of the evaluated person and attribute information of another person, a plurality of time thresholds associated with respective correspondence relations, the evaluation unit acquires the time threshold related to the attribute information of another person acquired by the attribute acquisition unit.

### Supplementary Note 15

The information processing device according to any one of Supplementary Notes 11 to 14, further including

an information acquisition unit that acquires information about a target commodity to be purchased by the another person, wherein

the evaluation unit specifies the designated conduct of the evaluated person by further using Information about a target commodity acquired by the information acquisition unit with respect to another person the attribute information of whom is acquired by the attribute acquisition unit.

### Supplementary Note 16

The Information processing device according to Supplementary Note 15, further including:

an ID acquisition unit that acquires a personal ID individually distinguishing the another person, and

a history acquisition unit that acquires purchase history information of the another person based on the acquired personal ID, wherein

the evaluation unit specifies the designated conduct of the evaluated person by further using information about a target commodity acquired by the information acquisition unit and purchase history information acquired by the history acquisition unit, with respect to another person the attribute information of whom is acquired by the attribute acquisition unit.

### Supplementary Note 17

An information processing device including:

a recognition unit that recognizes a conduct of an evaluated person;

an information acquisition unit that acquires information about a target commodity to be purchased by another person; and

an evaluation unit that evaluates a conduct of the evaluated person based on a recognition result of a designated conduct of the evaluated person by the recognition unit, the designated conduct being related to target commodity information acquired by the information acquisition unit.

### Supplementary Note 18

The information processing device according to Supplementary Note 17, further including:

an ID acquisition unit that acquires a personal ID individually distinguishing the another person purchasing a target commodity indicated by information acquired by the information acquisition unit, and

a history acquisition unit that acquires purchase history information of the another person based on the acquired personal ID, wherein

the evaluation unit evaluates a conduct of the evaluated person based on a recognition result of a designated conduct of the evaluated person by the recognition unit, the designated conduct being related to target commodity information acquired by the information acquisition unit and purchase history information acquired by the history acquisition unit.

### Supplementary Note 19

The information processing device according to Supplementary Note 17 or 18, wherein

the evaluation unit acquires a time threshold related to information about the target commodity acquired by the information acquisition unit, and evaluates a conduct of the evaluated person by further using the acquired time threshold and an acquisition time of information about the target commodity by the information acquisition unit.

### Supplementary Note 20

The information processing device according to Supplementary Note 19, wherein,

from correspondence information further including, in addition to a plurality of correspondence relations between a designated conduct expected of the evaluated person and commodity information, a plurality of time thresholds associated with respective correspondence relations, the evaluation unit acquires the time threshold related to information about the target commodity acquired by the information acquisition unit.

### Supplementary Note 21

The information processing device according to any one of Supplementary Notes 1 to 20, further including:

an ID acquisition unit that acquires a personal ID individually distinguishing the another person, and

a habit acquisition unit that acquires habit information of the another person based on the acquired personal ID, wherein

the evaluation unit determines necessity or unnecessity of an evaluation using the designated conduct of the evaluated person, based on the acquired habit information.

### Supplementary Note 22

The information processing device according to any one of Supplementary Notes 1 to 21, wherein

the recognition unit recognizes, as a conduct of the evaluated person, at least one item of utterance or no utterance, an utterance content, an utterance characteristic, and an action, and

the evaluation unit specifies, as the designated conduct of the evaluated person, at least one of any utterance of the evaluated person, a designated utterance content of the evaluated person, a designated utterance characteristic of the evaluated person, and a designated action of the evaluated person.

### Supplementary Note 23

The information processing device according to any one of Supplementary Notes 1 to 22, wherein

the evaluation unit accumulates, for a predetermined period, data associating the evaluation result with a detecting result of the trigger state of another person and a recognition result of a conduct of the evaluated person, the detecting result and the recognition result being bases of the evaluation result, and time information of each result, and outputs a list of accumulated data.

### Supplementary Note 24

The information processing device according to any one of Supplementary Notes 1 to 23, wherein

the evaluation unit successively outputs the evaluation result or alert information related to the result.

Each of the aforementioned information processing devices may be specified as a device including a processor and a memory, and executing a conduct evaluation method described below by causing the processor to execute a code stored in the memory.

### Supplementary Note 25

A conduct evaluation method executed by at least one computer, the conduct evaluation method including:

recognizing a conduct of an evaluated person;

detecting a trigger state of another person; and

evaluating a conduct of the evaluated person based on the recognition result of a designated conduct of the evaluated person, the designated conduct being related to the detected trigger state of another person.

### Supplementary Note 26

The conduct evaluation method according to Supplementary Note 25, further including,

from correspondence information including a plurality of correspondence relations between a designated conduct expected of the evaluated person and a state of another person, specifying the designated conduct of the evaluated person, the designated conduct being related to the detected trigger state of another person.

### Supplementary Note 27

The conduct evaluation method according to Supplementary Note 25 or 26, further including

acquiring a time threshold related to the detected trigger state of another person, wherein

the evaluation evaluates a conduct of the evaluated person by further using a recognition result of a designated conduct of the evaluated person or time information of the recognized designated conduct of the evaluated person, the acquired time threshold, and a detecting time of the trigger state of the another person.

### Supplementary Note 28

The conduct evaluation method according to Supplementary Note 27, wherein,

from correspondence information further including, in addition to a plurality of correspondence relations between a designated conduct expected of the evaluated person and a state of another person, a plurality of time thresholds associated with respective correspondence relations, acquisition of the time threshold acquires the time threshold related to the detected trigger state of another person.

### Supplementary Note 29

The conduct evaluation method according to any one of Supplementary Notes 25 to 28, further including

acquiring attribute information of the another person, wherein

the evaluation specifies the designated conduct of the evaluated person by further using the acquired attribute information with respect to another person the trigger state of whom is detected.

### Supplementary Note 30

The conduct evaluation method according to Supplementary Note 29, wherein,

from correspondence information including a plurality of correspondence relations between a designated conduct expected of the evaluated person, a state of another person, and attribute information of another person, specification of the designated conduct of the evaluated person specifies the designated conduct of the evaluated person, the designated conduct being related to the detected trigger state of another person and the acquired attribute information of another person.

### Supplementary Note 31

The conduct evaluation method according to any one of Supplementary Notes 25 to 30, further including:

acquiring information about a target commodity to be purchased by the another person, and

specifying the designated conduct of the evaluated person by further using the acquired information about a target commodity with respect to another person the trigger state of whom is detected.

### Supplementary Note 32

The conduct evaluation method according to Supplementary Note 31, further including:

acquiring a personal ID individually distinguishing the another person, and

acquiring purchase history information of the another person based on the acquired personal ID, wherein

specification of the designated conduct of the evaluated person specifies the designated conduct of the evaluated person by further using the acquired information about a target commodity and the acquired purchase history information, with respect to another person the trigger state of whom is detected.

### Supplementary Note 33

The conduct evaluation method according to any one of Supplementary Notes 25 to 32, further including,

based on time information of the detected trigger state of another person and time information of the recognized conduct of the evaluated person, specifying a conduct of the evaluated person evaluated with respect to a detected trigger state of another person from one or more recognized conducts of the evaluated person, wherein

the evaluation evaluates a conduct of the evaluated person by checking the specified conduct of the evaluated person against the designated conduct of the evaluated person, the designated conduct being related to the trigger state of the another person.

### Supplementary Note 34

The conduct evaluation method according to Supplementary Note 33, wherein

specification of the conduct of the evaluated person specifies a conduct of the evaluated person to be evaluated, by further using positional information of another person the trigger state of whom is detected and positional information of the evaluated person a conduct of whom is recognized.

### Supplementary Note 35

A conduct evaluation method executed by at least one computer, the conduct evaluation method including:

recognizing a conduct of an evaluated person;

acquiring attribute information of another person; and

evaluating a conduct of the evaluated person based on the recognition result of a designated conduct of the evaluated person, the designated conduct being related to the acquired attribute information of another person.

### Supplementary Note 36

The conduct evaluation method according to Supplementary Note 35, further including,

from correspondence information including a plurality of correspondence relations between a designated conduct expected of the evaluated person and attribute information of another person, specifying the designated conduct of the evaluated person, the designated conduct being related to the acquired attribute information of another person.

### Supplementary Note 37

The conduct evaluation method according to Supplementary Note 35 or 36, further including

acquiring a time threshold related to the acquired attribute information of another person, wherein

the evaluation evaluates a conduct of the evaluated person by further using the acquired time threshold and an acquisition time of the attribute information of the another person.

### Supplementary Note 38

The conduct evaluation method according to Supplementary Note 37, wherein,

from correspondence information further including, in addition to a plurality of correspondence relations between a designated conduct expected of the evaluated person and attribute information of another person, a plurality of time thresholds associated with respective correspondence relations, acquisition of the time threshold acquires the time threshold related to the acquired attribute information of another person.

### Supplementary Note 39

The conduct evaluation method according to any one of Supplementary Notes 35 to 38, further including:

acquiring information about a target commodity to be purchased by the another person, and

specifying the designated conduct of the evaluated person by further using the acquired information about a target commodity with respect to another person the attribute information of whom is acquired.

### Supplementary Note 40

The conduct evaluation method according to Supplementary Note 39, further including:

acquiring a personal ID individually distinguishing the another person, and

acquiring purchase history information of the another person based on the acquired personal ID, wherein

specification of the designated conduct of the evaluated person specifies the designated conduct of the evaluated person by further using the acquired information about a target commodity and the acquired purchase history information, with respect to another person the attribute information of whom is acquired.

### Supplementary Note 41

A conduct evaluation method executed by at least one computer, the conduct evaluation method including:

recognizing a conduct of an evaluated person;

acquiring information about a target commodity to be purchased by another person; and

evaluating a conduct of the evaluated person based on the recognition result of a designated conduct of the evaluated person, the designated conduct being related to the acquired target commodity information.

### Supplementary Note 42

The conduct evaluation method according to Supplementary Note 41, further including:

acquiring a personal ID individually distinguishing the another person purchasing a target commodity indicated by the acquired information, and

acquiring purchase history information of the another person based on the acquired personal ID, wherein

the evaluation evaluates a conduct of the evaluated person based on the recognition result of a designated conduct of the evaluated person, the designated conduct being related to the acquired target commodity information and the acquired purchase history information.

### Supplementary Note 43

The conduct evaluation method according to Supplementary Note 41 or 42, further including

acquiring a time threshold related to the acquired information about the target commodity, wherein

the evaluation evaluates a conduct of the evaluated person by further using the acquired time threshold and an acquisition time of information about the target commodity.

### Supplementary Note 44

The conduct evaluation method according to Supplementary Note 43, wherein,

from correspondence information further including, in addition to a plurality of correspondence relations between a designated conduct expected of the evaluated person and commodity information, a plurality of time thresholds associated with respective correspondence relation, acquisition of the time threshold acquires the time threshold related to the acquired information about the target commodity.

### Supplementary Note 45

The conduct evaluation method according to any one of Supplementary Notes 25 to 44, further including:

acquiring a personal ID individually distinguishing the another person;

acquiring habit information of the another person based on the acquired personal ID; and

determining necessity or unnecessity of an evaluation using the designated conduct of the evaluated person, based on the acquired habit information.

### Supplementary Note 46

The conduct evaluation method according to any one of Supplementary Notes 25 to 45, wherein

the recognition recognizes, as a conduct of the evaluated person, at least one item of utterance or no utterance, an utterance content, an utterance characteristic, and an action, and

the evaluation specifies any utterance of the evaluated person, a designated utterance contest of the evaluated person, a designated utterance characteristic of the evaluated person, and a designated action.

### Supplementary Note 47

The conduct evaluation method according to any one of Supplementary Notes 25 to 46, further including:

accumulating, for a predetermined period, data associating the evaluation result with a detecting result of the trigger state of another person and a recognition result of a conduct of the evaluated person, the detecting result and the recognition result being bases of the evaluation result, and time information of each result; and

outputting a list of the accumulated data.

### Supplementary Note 48

The conduct evaluation method according to any one of Supplementary Notes 25 to 47, further including

successively outputting the evaluation result or alert information related to the result.

### Supplementary Note 49

A program causing at least one computer to execute the conduct evaluation method according to any one of Supplementary Notes 25 to 48.

The present invention has been described with the aforementioned example embodiments as exemplary examples. However, the present invention is not limited to the aforementioned example embodiments. In other words, various embodiments that may be understood by a person skilled in the art may be applied to the present invention, within the scope thereof.

This application claims priority based on Japanese Patent Application No. 2014-245898 filed on Dec. 4, 2014, the disclosure of which is hereby incorporated by reference thereto in its entirety.

### REFERENCE SIGNS LIST

1 Information processing device (evaluation device)

2 CPU

3 Memory

4 Input-output I/F

5 Communication unit

11 Recognition unit

12 Detection unit

13 Evaluation unit

14 Specification unit

15 Rule table

17 Attribute acquisition unit

18 Information acquisition unit

1. An information processing device comprising:
a processor,
the processor executes instruction to:
recognize a conduct of an evaluated person;
detect a trigger state which is a state of a person other than the evaluated person and a state of triggering the conduct of the evaluated person; and
evaluate the conduct of the evaluated person using the trigger state detected and a recognition result recognized, the recognition result being related to the conduct of the evaluated person.

2. The information processing device according to claim 1, wherein
the processor
specifies a designated conduct of the evaluated person in response to the trigger state based on a plurality of pieces of relation data, the designated conduct being the conduct of the evaluated person and being expected in response to the trigger state, the plurality of pieces of relation data being data associating the trigger state with the designated conduct, the trigger state being detected, and
evaluates the conduct of the evaluated person based on the designated conduct specified and the recognition result.

3. The information processing device according to claim 1, wherein
the processor
acquires a time threshold related to the trigger state detected based on the plurality of pieces of relation data, the plurality of pieces of relation data being data associating the trigger state with the time threshold, and
evaluates the conduct of the evaluated person using further time information related to the conduct of the evaluated person and the time threshold.

4. The information processing device according to claim 1, wherein the processor executes further instruction to:
acquire attribute information of a person performing a conduct in the trigger state, wherein
the processor
specifies the designated conduct from the plurality of pieces of relation data based on the attribute information acquired, the plurality of pieces of relation data being data associating the attribute information with the trigger state and the designated conduct, and
evaluates the conduct of the evaluated person based on the designated conduct specified and the recognition result.

5. The information processing device according to claim 1 wherein the processor executes further instruction to:
acquire information about a target commodity to be purchased by a person performing the conduct in the trigger state, wherein
the processor evaluates the conduct of the evaluated person using further the information about the target commodity acquired.

6. The information processing device according to claim 5,
wherein the processor executes further instruction to:
acquire personal Identification (ID) distinguishing a person performing the conduct in the trigger state; and
acquire purchase history information of the person performing the conduct in the trigger state based on the personal ID acquired, wherein
the processor evaluates the conduct of the evaluated person using further the purchase history information acquired.

7. The information processing device according to claim 1, wherein the processor executes further instruction to:
specify an evaluation target conduct of the evaluated person in response to the trigger state from the conduct of the evaluated person recognized based on time information related to the trigger state detected and time information related to the conduct of the evaluated person, wherein
the processor evaluates the evaluation target conduct of the evaluated person specified.

8. The information processing device according to claim 7, wherein
the processor specifies the evaluation target conduct of the evaluated person using further positional information related to the trigger state detected and positional information of the evaluated person.

9. (canceled)

10. (canceled)

11. The information processing device according to claim 1 wherein the processor executes further instruction to:
acquire a personal ID distinguishing a person being other than the evaluated person, the person performing a conduct which triggers the conduct of the evaluated person, and
acquire habit information of a person related to the personal ID acquired, wherein
the processor
determines whether to perform an evaluation on the evaluated person based on the habit information acquired, and
evaluates the conduct of the evaluated person when determining to perform the evaluation.

12. The information processing device according to claim 1, wherein
the processor recognizes, as the conduct of the evaluated person, at least one item of utterance or no utterance, an utterance content, an utterance characteristic, and an action.

13. The information processing device according to claim 1, wherein
the processor
accumulates data associating an evaluation result with the conduct of the evaluated person, the conduct being a basis of the evaluation, and time information related to the conduct, and
outputs accumulated data at a predetermined timing.

14. The information processing device according to claim 1, wherein
the processor successively outputs an evaluation result or alert information related to the evaluation result.

15. A conduct evaluation method comprising: by a computer,
recognizing a conduct of an evaluated person;
detecting a trigger state which is a state of a person other than the evaluated person and a state of triggering the conduct of the evaluated person; and
evaluating the conduct of the evaluated person using the trigger state detected, and a recognition result related to the conduct of the evaluated person.

16. (canceled)

17. (canceled)

18. A non-transitory computer program storage medium storing a processing procedure causing a computer to perform:
recognizing a conduct of an evaluated person;
detecting a trigger state which is a state of a person other than the evaluated person and a state of triggering the conduct of the evaluated person; and
evaluating the conduct of the evaluated person using the trigger state detected and a recognition result which is related to the conduct of the evaluated person.

19. (canceled)

20. (canceled)
